(19) United States
(12) Patent Application Publication
(10) Pub. No.: US 2023/0177490 A1
(43) Pub. Date: Jun. 8, 2023

(54) CRYPTOGRAPHIC ASSET GENERATION USING SHORT RANGE WIRELESS COMMUNICATION

(71) Applicant: Sill Group LLC, Middletown, DE (US)

(72) Inventors: William Moore, Kent, WA (US); Ryan Richards, Palmer Lake, CO (US); Joseph Ginzburg, Los Angeles, CA (US); Daniel Davood, Los Angeles, CA (US)

(21) Appl. No.: 18/062,250

(22) Filed: Dec. 6, 2022

Related U.S. Application Data
(60) Provisional application No. 63/287,000, filed on Dec. 7, 2021.

(51) Int. Cl. G06Q 20/36

(52) U.S. Cl. CPC G06Q 20/3672; G06Q 2220/00

(57) ABSTRACT

This disclosure is directed to methods and systems for cryptographic asset generation using short range wireless communication. The methods and systems enable creation and distribution of cryptographic assets with proof of in-person contact over various wireless technologies, including but not limited to, NFC, low-energy Bluetooth, and others. This is achieved by passing a cryptographic asset template from a creator device to a collector device via NFC. The cryptographic asset template is passed to a server for confirmation and subsequently starts the process of minting a smart contract on a blockchain. The processes disclosed herein include cryptographic asset template creation, template distribution, template-to-cryptographic asset creation, and smart contract execution.

### CROSS-REFERENCE TO RELATED APPLICATION

This Application claims the benefit under 35 U.S.C. § 119(e) of U.S. Provisional Patent Application Ser. No. 63/287,000, entitled “NON FUNGIBLE TOKEN (NFT) GENERATION USING SHORT RANGE WIRELESS COMMUNICATION” filed on Dec. 7, 2021, which is herein incorporated by reference in its entirety.

### APPENDIX

This patent application includes a submitted Appendix of Drawings, which is herein incorporated by reference in its entirety.

### TECHNICAL FIELD

The present disclosure is generally related to the generation and/or management of cryptographic assets.

### BACKGROUND

A cryptographic asset such as a non-fungible token (NFT) is a unique identifier for a piece of content, such as artwork, music, writing, and so on. An NFT is a hash value, along with some other metadata about a purchased work—such as its title, the author, and the date when it was created. Algorithms can accept an input (a digital work being sold) and produce a hash (the NFT) that uniquely identifies the good and its relevant metadata. However, unless an NFT collector personally knows an NFT seller, the collector may have no way of verifying the authenticity of a listed item. Moreover, if the original transaction was fraudulent to begin with, the value of the NFT (which is supposed to be a verifiable token of ownership) can be undermined.

### BRIEF DESCRIPTION OF THE DRAWINGS

FIG. 1 is a block diagram illustrating components of at least a portion of an exemplary blockchain, in accordance with one or more embodiments of this disclosure.

FIG. 2A is a drawing illustrating an integrity verification scheme performed in part by applying hash functions, in accordance with one or more embodiments of this disclosure.

FIG. 2B is a block diagram illustrating an example cryptographic wallet, in accordance with one or more embodiments of this disclosure.

FIG. 3 is a block diagram illustrating an example environment for cryptographic asset generation, in accordance with one or more embodiments.

FIG. 4 is a flow diagram illustrating an example process for product authentication, in accordance with one or more embodiments.

FIGS. 5A-5B illustrate an example graphical user interface (GUI) of a cryptographic asset creator device for cryptographic asset generation using short range wireless communication, in accordance with one or more embodiments.

FIGS. 6A-6B illustrate an example GUI of a cryptographic asset creator device for cryptographic asset using short range wireless communication, in accordance with one or more embodiments.

FIGS. 7A-7B illustrate an example GUI of a cryptographic asset creator device for cryptographic asset generation using short range wireless communication, in accordance with one or more embodiments.

FIGS. 8A-8B illustrate an example GUI of a cryptographic asset collector device for cryptographic asset generation using short range wireless communication, in accordance with one or more embodiments.

FIGS. 9A-9B illustrate an example GUI of a cryptographic asset collector device for cryptographic asset generation using short range wireless communication, in accordance with one or more embodiments.

FIG. 10 is a flow diagram illustrating an example process for cryptographic asset generation using short range wireless communication, in accordance with one or more embodiments.

FIG. 11 is a flow diagram illustrating another example process for cryptographic asset generation using short range wireless communication, in accordance with one or more embodiments.

FIG. 12 is a flow diagram illustrating an example process performed by a first computer device for cryptographic asset generation using short range wireless communication, in accordance with one or more embodiments.

FIG. 13A is an example of a user interface for a creator device, in accordance with one or more embodiments.

FIG. 13B is another example of a user interface for a creator device, in accordance with one or more embodiments.

FIG. 14A is an example of a user interface for a collector device, in accordance with one or more embodiments.

FIG. 14B is another example of a user interface for a collector device, in accordance with one or more embodiments.

FIG. 15 is a block diagram illustrating an example machine learning (ML) system, in accordance with one or more embodiments.

FIG. 16 is a block diagram illustrating an example computer system, in accordance with one or more embodiments.

### DETAILED DESCRIPTION

Cryptographic assets, such as cryptocurrency or non-fungible tokens (NFTs) can enable systems and methods for authenticating digital art and products, such as products from original manufacturers and/or resellers, providing a trusted and reliable mechanism for buyers and sellers to prove the authenticity of a product and for authenticators to establish an authentication that can be relied on during downstream transactions. A digital collectible can be an image, formatted text, a video clip, an audio clip, a game/game clip, any other digital collectible, or a combination thereof. Blockchain-based authentication enables NFT creators and collectors or other entities within a chain of commerce (e.g., suppliers, manufacturers, distributors, retails, consumers, consignors, resellers) to verify the authenticity of items by way of trusted authenticators and trusted audit processes. An NFT creator can sometimes be referred to as an NFT transmitter. An NFT creator can be a celebrity (e.g., athlete, actor, etc.), an influencer, a content provider (e.g., television show), a company, a university, etc. An NFT collector can sometimes be referred to as an NFT receiver. An NFT collector can be an individual (or a group of individuals), a company or business entity, a university, a museum, etc. The embodiments for NFT-based authentication disclosed herein enable users to rely on authentication via the use of cryptography, blockchain, digital assets, and/or tagging hardware/software such as Near Field Communication (NFC) or other technologies that support the need to define a digital equivalent (or twin) of a physical product, non-fungible tokens (e.g., ERC721 non-fungible tokens), and so on.

The embodiments disclosed herein describe methods, systems, and apparatus to enable creation and distribution of cryptographic assets with proof of in-person contact over various wireless technologies, including but not limited to, NFC, low-energy Bluetooth, and others. This is achieved by passing a template from a creator device to a collector device via NFC. In some implementations, the template is a cryptographic asset template, such as an NFT template. The NFT template is passed to a server for confirmation and subsequently starts the process of minting a smart contract on a blockchain. The processes disclosed herein include NFT template creation, template distribution, template-to-NFT creation, and smart contract execution. In some embodiments, a first computer device generates an NFT template comprising a digital collectible and metadata identifying a first user of the first computer device. The first computer device sends the NFT template to a server for validating the NFT template based on the metadata. The first computer device receives an encrypted version of the NFT template from the server. The NFT template is encrypted using a shared secret key to prevent duplicates of the NFT template from being generated. The first computer device sends the encrypted version of the NFT template received from the server to a second computer device of a second user for minting the NFT by the second user. The first computer device receives a confirmation from the second computer device indicating that the second computer device received the encrypted version of the NFT template for minting the NFT. The first computer device receives a notification from the server comprising an indication that the NFT was minted on a blockchain and a count of a number of minted NFTs associated with the first user. If the first computer device is temporarily out of service or has a bad wireless or cellular signal, the notification is delivered once the connection is restored.

In some alternate embodiments, a portion of the transaction or the entire transaction is performed in a virtual world, such as a metaverse. A metaverse is a virtual iteration of the Internet, supporting persistent online 3-D virtual environments through conventional personal computing, as well as virtual and augmented reality headsets. For example, a real-world celebrity contact with an NFT collector can occur, which results in the NFT creator (the celebrity) transferring an NFT template over NFC or the Internet to an NFT collector. Once, the NFT is minted, the NFT is usable by the NFT collector's avatar in the metaverse, e.g., the NFT can become an object in an online game, the NFT can be a trophy that the avatar hangs on a virtual wall in the metaverse, or the NFT can depict a pair of collectible shoes that an avatar wears, etc. In other embodiments, a virtual avatar of the NFT creator can virtually transfer an NFT template to an avatar of the NFT collector in the metaverse. Thus, the virtual contact between the two avatars in the metaverse generates an NFT that the real-world NFT collector can mint and own on a blockchain.

The advantages and benefits of the methods, systems, and apparatus disclosed herein include reducing the amount of repeated or duplicated effort in authenticating digital collectibles, digital art, and products, thereby saving valuable resources required for performing such activities. The embodiments provide methods for digital artists, athletes, other celebrities, and NFT providers to partner together, such that a digital artist or other NFT provider can benefit from digital transactions, increasing opportunities and reaching a wider audience. The embodiments disclosed herein provide a more transparent, efficient, and accessible solution that connects creators, collectors, businesses, and consumers. The NFT generated serves as digital proof of, e.g., a face-to-face physical contact between the creator and collector, or an in-person, face-to-face digital signature. In some embodiments, the NFT serves as digital proof of a virtual contact between an avatar of a real-world celebrity and an avatar of an NFT collector in a metaverse.

Embodiments of the present disclosure will be described more thoroughly from now on with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples. These and other aspects, features, and implementations can be expressed as methods, apparatus, systems, components, program products, means or steps for performing a function, and in other ways. These and other aspects, features, and implementations will become apparent from the following descriptions, including the claims.

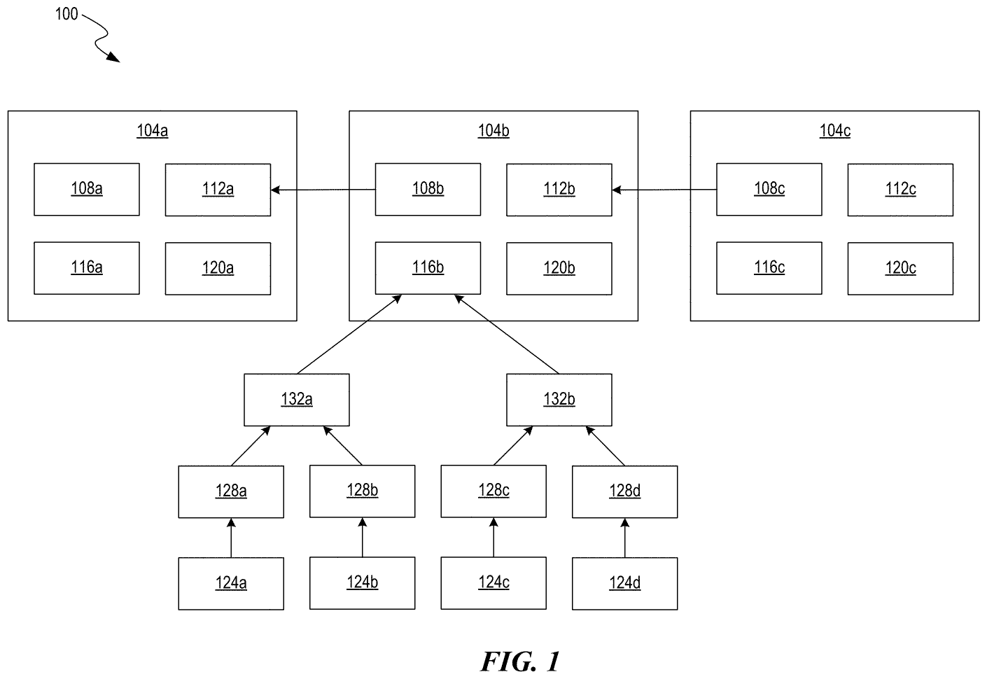

FIG. 1 is a block diagram illustrating components of at least a portion of an example blockchain system 100, in accordance with one or more embodiments of this disclosure. Blockchain system 100 includes blockchain 104. In embodiments, the blockchain 104 is a distributed ledger of transactions (e.g., a continuously growing list of records, such as records of transactions for digital assets such as cryptocurrency, bitcoin, or electronic cash) that is maintained by a blockchain system 100. For example, the blockchain 104 is stored redundantly at multiple nodes (e.g., computers) of a blockchain network. Each node in the blockchain network can store a complete replica of the entirety of blockchain 104. In some embodiments, the blockchain system 100 implements storage of an identical blockchain at each node, even when nodes receive transactions in different orderings. The blockchain 104 shown by FIG. 1 includes blocks such as block 104a, block 104b, and/or block 104c. Likewise, embodiments of the blockchain system 100 can include different and/or additional components or be connected in different ways.

The terms “blockchain” and “chain” are used interchangeably herein. In embodiments, the blockchain 104 is a distributed database that is shared among the nodes of a computer network. As a database, the blockchain 104 stores information electronically in a digital format. The blockchain 104 can maintain a secure and decentralized record of transactions (e.g., transactions such as transaction 124a and/or transaction 124b). For example, the ERC-721 or ERC-1155 standards are used for maintaining a secure and decentralized record of transactions. The blockchain 104 provides fidelity and security for the data record. In embodiments, blockchain 104 collects information together in groups, known as “blocks” (e.g., blocks such as block 104a, block 104b, and/or block 104c) that hold sets of information.

The blockchain 104 structures its data into chunks (blocks) (e.g., blocks such as block 104a, block 104b, and/or block 104c) that are strung together. Blocks (e.g., block 104c) have certain storage capacities and, when filled, are closed and linked to a previously filled block (e.g., block 104b), forming a chain of data known as the “blockchain.” New information that follows a freshly added block (e.g., block 104b) is compiled into a newly formed block (e.g., block 104c) that will then also be added to the blockchain 104 once filled. The data structure inherently makes an irreversible timeline of data when implemented in a decentralized nature. When a block is filled, it becomes a part of this timeline of blocks. Each block (e.g., block 104a) in the blockchain system 100 is given an exact timestamp (e.g., timestamp 112a) when it is added to the blockchain system 100. In the example of FIG. 1, blockchain system 100 includes multiple blocks. Each of the blocks (e.g., block 104a, block 104b, block 104c) can represent one or multiple transactions and can include a cryptographic hash of the previous block (e.g., previous hashes 108a-c), a timestamp (e.g., timestamps 112a-c), a transactions root hash (e.g., 116a-c), and a nonce (e.g., 120a-c). A transactions root hash (e.g., transactions root hash 116b) indicates the proof that the block 104b contains all the transactions in the proper order. Transactions root hash 116b proves the integrity of transactions in the block 104b without presenting all transactions.

In embodiments, the timestamp 112a-c of each of corresponding blocks of block 104a, block 104b, block 104c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 120a-c of each of corresponding blocks of block 104a, block 104b, block 104c include any generated random or semi-random number. The nonce can be used by miners during proof of work (PoW), which refers to a form of adding new blocks of transactions to blockchain 104. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks of block 104a, block 104b, block 104c of blockchain 104 can include respective block hash, e.g., transactions root hash 116a, transactions root hash 116b, and transactions root hash 116c. Each of block hashes 116a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 1, block 104b records transactions 124a-d. Each of the leaf nodes 128a-d contain a hash corresponding to transactions 124a-d respectively. As described above, a hash (e.g., the hash in leaf node such as node 128a) can be a hash of components of a transaction (e.g., transaction 124a), for example, a reference that identifies an output of a prior transaction that is input to the transaction 124a, an attachment, and a command. Each of the non-leaf nodes of node 132a and node 132b can contain a hash of the hashes of its child nodes (e.g., leaf nodes such as node 128a and node 128b). In this example, node 132a can contain a hash of the hashes contained in node 128a, node 128b and node 132b can contain a hash of the hashes contained in node 128c, node 128d. The root node, which includes (e.g., contains) transactions root hash 116b, can contain a hash of the hashes of child nodes 132a-b.

A Merkle tree representation of a transaction (e.g., transaction 124a) allows an entity needing access to the transaction 124a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 124a by generating a hash of the transaction summary and calculating the hashes of the nodes along the path to the root node. If the calculated hash of the root node matches the hash of node 128a of the transaction 124a, the transaction summary is confirmed as the one used in the transaction. Because only the portion of the Merkle tree relating to components that an entity needs is provided, the entity will not have access to other components. Thus, the confidentiality of the other components is not compromised.

In some examples, the blockchain system 100 is a bitcoin system developed to allow digital assets such as electronic cash to be transferred directly from one party to another without going through a central authority, such as financial institution (e.g., as described in the white paper entitled “Bitcoin: A Peer-to-Peer Electronic Cash System” by Satoshi Nakamoto, hereby incorporated by reference in its entirety). A bitcoin (an electronic coin) can be represented by a chain of transactions that transfers ownership from one party to another party.

To transfer ownership of a digital asset, such as a bitcoin, using the blockchain system 100, a new transaction, such as one of transactions 124a-d, is generated and added to a stack of transactions in a block, e.g., block 104b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset's identification number. The account for the asset identifies the first user as being the current owner of the asset. The first user (i.e., the current owner) creates a transaction (e.g., transaction 124a) against the account for the asset that indicates that the transaction 124a is a transfer of ownership and outputs a token identifying the second user as the next owner and a token identifying the asset. The transaction 124a is signed by the private key of the first user (i.e., the current owner), and the transaction 124a is evidence that the second user is now the new current owner and that ownership has been transferred from the first to the second user.

The transaction 124a (e.g., a new transaction), which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the transaction 124a (e.g., the new transaction). Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 104 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 100 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 124a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 124a in the blockchain 104 using a token that is a hash of node 128a of the computer code so that the computer code that is executed can be authenticated. When deployed, a constructor of the smart contract executes, initializing the smart contract and its state. The state of a smart contract is stored persistently in the blockchain 104. When a transaction 124a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 124a is recorded in the blockchain 104.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., transaction 124a) that transfers the ownership of the asset to the buyer and a transaction (e.g., transaction 124b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either of transaction 124a or transaction 124b is not successful, neither transaction is recorded.

When a message is sent to a smart contract to record a transaction 124a, the message is sent to each node that maintains a replica of the blockchain 104. Each node executes the computer code of the smart contract to implement the transaction 124a. For example, if a hundred nodes each maintain a replica of the blockchain 104, the computer code executes at each of the hundred nodes. When a node completes execution of the computer code, the result of the transaction 124a is recorded in the blockchain 104. The nodes employ a consensus algorithm to decide which transactions (e.g., transaction 124c) to keep and which transactions (e.g., transaction 124d) to discard. Although the execution of the computer code at each node helps ensure the authenticity of the blockchain 104, large amounts of computer resources are required to support such redundant execution of computer code.

Although blockchains can effectively store transactions 124a-d, the large amount of computer resources, such as storage and computational power, needed to maintain all the replicas of the blockchain can be problematic. To overcome this problem, some systems for storing transactions 124a-d do not use blockchains, but rather have each party to a transaction maintain its own copy of the transaction 124a. One such system is the Corda™ system developed by R3™ that provides a decentralized distributed ledger platform in which each participant in the platform has a node (e.g., computer system) that maintains its portion of the distributed ledger.

When parties agree on the terms of a transaction 124a, a party submits the transaction 124a to a notary, which is a trusted node, for notarization. The notary maintains a consumed output database of transaction outputs that have been input into other transactions. When a transaction 124a is received, the notary checks the inputs to the transaction 124a against the consumed output database to ensure that the outputs that the inputs reference have not been spent. If the inputs have not been spent, the notary updates the consumed output database to indicate that the referenced outputs have been spent, notarizes the transaction 124a (e.g., by signing the transaction or a transaction identifier with a private key of the notary), and sends the notarized transaction to the party that submitted the transaction 124a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., transaction 124b), the non-validating notary determines that the prior output of a prior transaction (e.g., transaction 124a), that is, the input of a current transaction, e.g., transaction 124b, has not been consumed. If the prior output has not been consumed, the non-validating notary notarizes the transaction 124b by signing a hash of node 128b of the transaction. To notarize a transaction 124b, a non-validating notary needs only the identification of the prior output (e.g., the hash of node 128a of the prior transaction (e.g., transaction 124a) and the index of the output) and the portion of the Merkle tree needed to calculate the hash of node 128b of the transaction 124b.

As described herein, in some embodiments, the blockchain system 100 uses one or more smart contracts to enable more complex transactions. For example, a validating notary validates a transaction (e.g., transaction 124d), which includes verifying that prior transactions 124a-c in a backchain of transactions are valid. The backchain refers to the collection of prior transactions (e.g., transaction 124c) of a transaction 124d, as well as prior transactions of transaction 124a, transaction 124b, and transaction 124c, and so on. To validate a transaction 124d, a validating notary invokes validation code of the transaction 124d. In one example, a validating notary invokes validation code of a smart contract of the transaction 124d. The validation code performs whatever checks are needed to comply with the terms applicable to the transaction 124d. This checking can include retrieving the public key of the owner from the prior transaction (e.g., transaction 124c) (pointed to by the input state of the transaction 124d) and checks the signature of the transaction 124d, ensuring that the prior output of a prior transaction that is input has not been consumed, and checking the validity of each transaction (e.g., transaction 124c) in the backchain of the transactions. If the validation code indicates that the transaction 124d is valid, the validating notary notarizes the transaction 124d and records the output of the prior transaction (e.g., transaction 124c) as consumed.

In some examples, to verify that the transactions 124a-d in a ledger stored at a node are correct, the blocks, e.g., block 104a, block 104b, block 104c in the blockchain 104 can be accessed from oldest block (e.g., block 104a) to newest block (e.g., block 104c), generating a new hash of the block 104c and comparing the new hash to the hash 108c generated when the block 104c was created. If the hashes are the same, then the transactions in the block are verified. In one example, the Bitcoin system also implements techniques to ensure that it would be infeasible to change a transaction 124a and regenerate the blockchain 104 by employing a computationally expensive technique to generate a nonce 120b that is added to the block when it is created. A bitcoin ledger is sometimes referred to as an Unspent Transaction Output (“UTXO”) set because it tracks the output of all transactions that have not yet been spent.

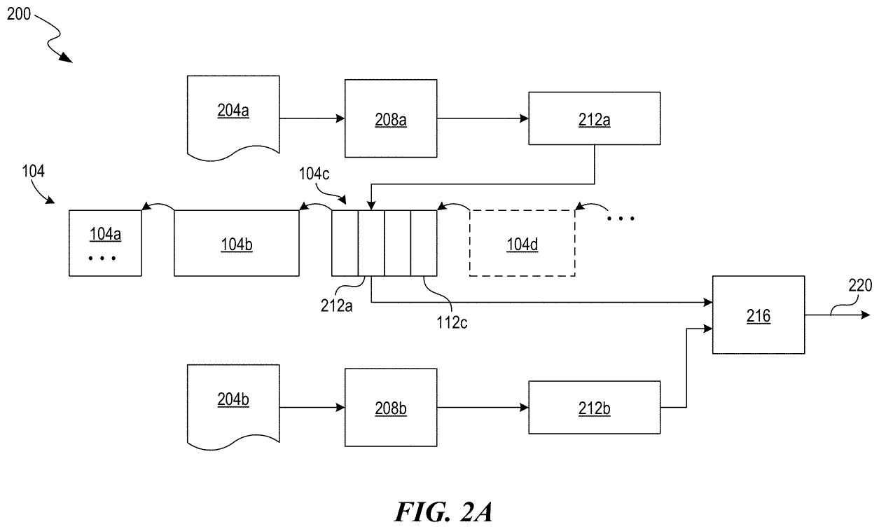

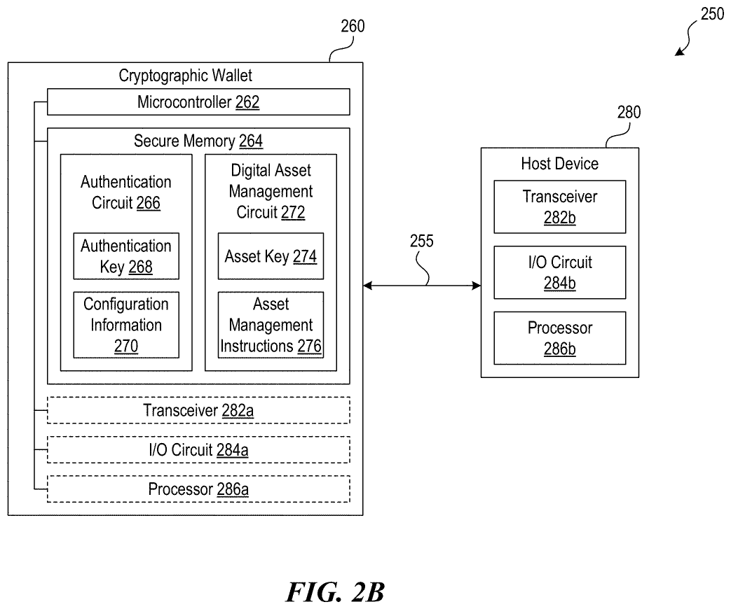

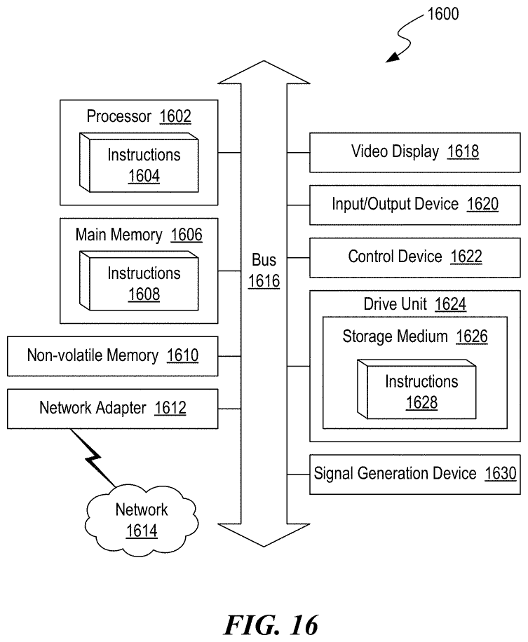

FIG. 2A is a drawing illustrating an example hash algorithm. The process 200 shown by FIG. 2A uses a hash algorithm to generate a non-fungible token (NFT) or perform a cryptographic transaction on a blockchain. An example blockchain 104, e.g., as shown in FIG. 2A, is also illustrated and described in detail with reference to FIG. 1. The process 200 can be performed by a computer system such as that described with reference to FIG. 16 and/or by nodes of the blockchain 104. Some embodiments include different and/or additional steps or perform steps in different orders.

In embodiments, a digital message, electronic art, a digital collectible, any other form of digital content, or a combination thereof digital content 204a can be hashed using hashing algorithm 208a. The hashing algorithm 208a (sometimes referred to as a “hash function”) can be a function used to map data of arbitrary size (e.g., digital content 204a) to fixed-size values (e.g., hash of values 212a). The values 212a that are returned by the hashing algorithm 208a can be called hash values, hash codes, digests, or hashes. The values 212a can be used to index a fixed-size table called a hash table. A hash table, also known as a hash map, is a data structure that implements an associative array or dictionary, which is an abstract data type that maps keys (e.g., digital content 204a) to values 212a.

The output of the hashed digital content (e.g., hash of values 212a) can be inserted into a block (e.g., block 104c) of the blockchain 104 (e.g., comprising blocks such as blocks such as block 104a, block 104b, block 104c-). The block 104c can include, among other things, information such as timestamp 112c. In order to verify that the block 104c is correct, a new hash 212b is generated by applying hashing algorithm 208b to the digital content 204b. The new hash 212b is compared to the hash of values 212a in the blockchain 104 at comparison step 216. If the new hash 212b is the same as the hash of values 212a of the block 104c, the comparison yields an indication that they match. For example, the decision 220 can indicate that the hashes of values 212a-b are the same or not. The hashes can be indicated to be the same if the characters of the hash match. The hashing algorithms 208a-b can include any suitable hashing algorithm. Examples include Message Digest 5 (MD5), Secure Hashing Algorithm (SHA) and/or the likes.

Components of the process 200 can generate or validate an NFT, which is a cryptographic asset that has a unique identification code and metadata that uniquely identifies the NFT. In one example, the digital content 204a can be hashed and minted to generate an NFT, or the digital content 204a can represent an NFT that is verified using the process 200 and the digital content 204b. An NFT can include digital data stored in the blockchain 104. The ownership of an NFT is recorded in the blockchain 104 and transferrable by an owner, allowing the NFT to be sold and traded. The NFT contains a reference to digital files such as photos, videos, or audio (e.g., digital content 204a). Because NFTs are uniquely identifiable assets, they differ from cryptocurrencies, which are fungible. In particular, NFTs function like cryptographic tokens, but unlike cryptocurrencies such as Bitcoin or Ethereum™, NFTs are not mutually interchangeable, and so are not fungible.

The NFT can be associated with a particular digital or physical asset such as images, art, music, and sport highlights and can confer licensing rights to use the asset for a specified purpose. As with other assets, NFTs are recorded on a blockchain when a blockchain 104 concatenates records containing cryptographic hashes—sets of characters that identify a set of data—onto previous records, creating a chain of identifiable data blocks such as block 104a, block 104b, block 104c, and block 104d. A cryptographic transaction process enables authentication of each digital file by providing a digital signature that tracks NFT ownership. In embodiments, a data link that is part of the NFT records points to details about where the associated art is stored.

Minting an NFT can refer to the process of turning a digital file (e.g., digital content 204a) into a crypto collectible or digital asset on blockchain 104 (e.g., the Ethereum™ blockchain). The digital item or file (e.g., digital content 204a) can be stored in the blockchain 104 and cannot be able to be edited, modified, or deleted. The process of uploading a specific item onto the blockchain 104 is known as “minting.” For example, “NFT minting” can refer to a process by which a digital art or digital content 204a becomes a part of the Ethereum™ blockchain. Thus, the process turns digital content 204a into a crypto asset, which is easily traded or bought with cryptocurrencies on a digital marketplace without an intermediary.

FIG. 2B is a block diagram 250 illustrating an example cryptographic wallet 260. As a general overview, cryptographic wallet 260 is an electronic entity that allows users to securely manage digital assets. According to various embodiments, the cryptographic wallet 260 can be a hardware-based wallet (e.g., can include dedicated hardware component(s)), a software-based wallet, or a combination thereof. Example digital assets that can be stored and managed using the cryptographic wallet 260 include digital coins, digital tokens, and/or the like. In some embodiments, tokens are stored on a blockchain system, such as the blockchain system 100 described in FIG. 1. In some embodiments, the cryptographic wallet 260 may be capable of connecting to and managing assets that are native to or associated with multiple, different blockchain systems (e.g., including multiple blockchain systems having structure similar to or equivalent to blockchain system 100).

As defined herein, the terms “coin” and “token” refer to a digital representation of a particular asset, utility, ownership interest, and/or access right. Any suitable type of coin or token can be managed using various embodiments of the cryptographic wallet 260. In some embodiments, tokens include cryptocurrency, such as exchange tokens and/or stablecoins. Exchange tokens and/or stablecoins can be native to a particular blockchain system and, in some instances, can be backed by a value-stable asset, such as fiat currency, precious metal, oil, or another commodity. In some embodiments, tokens are utility tokens that provide access to a product or service rendered by an operator of the blockchain system 100 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership. In some embodiments, tokens are decentralized finance (DeFi) tokens. DeFi tokens can be used to access feature sets of DeFi software applications (dApps) built on the blockchain system 100. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system) or off-chain (e.g., implemented as computer software on computing devices that are separate from the blockchain system 100).

As shown, the cryptographic wallet 260 of FIG. 2B is communicatively coupled to the host device 280 (e.g., a mobile phone, a laptop, a tablet, a desktop computer, a wearable device, a point-of-sale (POS) terminal, an automated teller machine (ATM) and the like) via the communications link 255. In some embodiments, the host device 280 can extend the feature set available to the user of the cryptographic wallet 260 when it is coupled to the host device 280. For instance, the host device may provide the user with the ability to perform balance inquiries, convert tokens, access exchanges and/or marketplaces, perform transactions, access computing systems, and/or the like.

In some embodiments, the cryptographic wallet 260 and the host device 280 can be owned and/or operated by the same entity, user, or a group of users. For example, an individual owner of the cryptographic wallet 260 may also operate a personal computing device that acts as a host device 280 and provides enhanced user experience relative to the cryptographic wallet 260 (e.g., by providing a user interface that includes graphical features, immersive reality experience, virtual reality experience, or similar). In some embodiments, the cryptographic wallet 260 and the host device 280 can be owned and/or operated by different entities, users and/or groups of users. For example, the host device 280 can be a point-of-sale (POS) terminal at a merchant location, and the individual owner of the cryptographic wallet 260 may use the cryptographic wallet 260 as a method of payment for goods or services at the merchant location by communicatively coupling the two devices for a short period of time (e.g., via chip, via near-field communications (NFC), by scanning of a bar code, by causing the cryptographic wallet 260 to generate and display a quick response (QR) code, and/or the like) to transmit payment information from the cryptographic wallet 260 to the host device 280.

The cryptographic wallet 260 and the host device 280 can be physically separate and/or capable of being removably coupled. The ability to physically and communicatively uncouple the cryptographic wallet 260 from the host device 280 and other devices enables the air-gapped cryptographic wallet (e.g., cryptographic wallet 260) to act as “cold” storage, where the stored digital assets are moved offline and become inaccessible to the host device 280 and other devices. Further, the ability to physically and communicatively uncouple the cryptographic wallet 260 from the host device 280 allows the cryptographic wallet 260 to be implemented as a larger block of physical memory, which extends the storage capacity of the cryptographic wallet 260, similar to a safety deposit box or vault at a brick-and-mortar facility.

Accordingly, in some embodiments, the cryptographic wallet 260 and the host device 280 are physically separate entities. In such embodiments, the communications link 255 can include a computer network. For instance, the cryptographic wallet 260 and the host device 280 can be paired wirelessly via a short-range communications protocol (e.g., Bluetooth, ZigBee, infrared communication) or via another suitable network infrastructure. In some embodiments, the cryptographic wallet 260 and the host device 280 are removably coupled. For instance, the host device 280 can include a physical port, outlet, opening, or similar to receive and communicatively couple to the cryptographic wallet 260, directly or via a connector.

In some embodiments, the cryptographic wallet 260 includes tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the cryptographic wallet 260 can include an integrated circuit, such as a SIM card, a smart cart, and/or the like. For instance, in some embodiments, the cryptographic wallet 260 can be a physical smart card that includes an integrated circuit, such as a chip that can store data. In some embodiments, the cryptographic wallet 260 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the cryptographic wallet 260 and the host device 280 are non-removably coupled. For instance, various components of the cryptographic wallet 260 can be co-located with components of the host device 280 in the housing of the host device 280. In such embodiments, the host device 280 can be a mobile device, such as a phone, a wearable, or similar, and the cryptographic wallet 260 can be built into the host device. The integration between the cryptographic wallet 260 and the host device 280 can enable improved user experience and extend the feature set of the cryptographic wallet 260 while preserving computing resources (e.g., by sharing the computing resources, such as transceiver, processor, and/or display or the host device 280). The integration further enables the ease of asset transfer between parties. The integration can further enhance loss protection options, as recovering a password or similar authentication information, rather than recovering a physical device, can be sufficient to restore access to digital assets stored in the cryptographic wallet 260. In some embodiments, the non-removably coupled cryptographic wallet can be air-gapped by, for example, disconnecting the host device 280 from the Internet.

As shown, the cryptographic wallet 260 can include a microcontroller 262. The microcontroller 262 can include or be communicatively coupled to (e.g., via a bus or similar communication pathway) at least a secure memory 264. The cryptographic wallet 260 can further include a transceiver 282a, and input/output circuit 284a, and/or a processor 286a. In some embodiments, however, some or all of these components can be omitted.

In some embodiments, the cryptographic wallet 260 can include a transceiver 282a and therefore can be capable of independently connecting to a network and exchanging electronic messages with other computing devices. In some embodiments, the cryptographic wallet 260 does not include a transceiver 282a. The cryptographic wallet 260 can be capable of connecting to or accessible from a network, via the transceiver 282b of the host device 280, when the cryptographic wallet 260 is docked to the host device 280. For example, in some embodiments, the user of the cryptographic wallet 260 can participate in token exchange activities on decentralized exchanges when the cryptographic wallet 260 is connected to the host device 280.

In some embodiments, the cryptographic wallet 260 can include an input/output circuit 284a, which may include user-interactive controls, such as buttons, sliders, gesture-responsive controls, and/or the like. The user-interactive controls can allow a user of the cryptographic wallet 260 to interact with the cryptographic wallet 260 (e.g., perform balance inquiries, convert tokens, access exchanges and/or marketplaces, perform transactions, access computing systems, and/or the like). In some embodiments, the user can access an expanded feature set, via the input/output circuit 284b of the host device 280, when the cryptographic wallet 260 is docked to the host device 280. For example, host device 280 can include computer-executable code structured to securely access data from the secure memory 264 of the cryptographic wallet 260 and to perform operations using the data. The data can include authentication information, configuration information, asset keys, and/or token management instructions. The data can be used by an application that executes on or by the host device 280. The data can be used to construct application programming interface (API) calls to other applications that require or use the data provided by cryptographic wallet 260. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 264 is shown to include an authentication circuit 266 and a digital asset management circuit 272. The authentication circuit 266 and/or digital asset management circuit 272 include computer-executable code that, when executed by one or more processors, such as one or more processors of processor 286a and/or processor 286b, performs specialized computer-executable operations. For example, the authentication circuit 266 can be structured to cause the cryptographic wallet 260 to establish, maintain and manage a secure electronic connection with another computing device, such as the host device 280. The digital asset management circuit 272 can be structured to cause the cryptographic wallet 260 to allow a user to manage the digital assets accessible via the cryptographic wallet 260. In some embodiments, the authentication circuit 266 and the digital asset management circuit 272 are combined in whole or in part.

As shown, the authentication circuit 266 can include retrievably stored security, authentication, and/or authorization data, such as the authentication key 268. The authentication key 268 can be a numerical, alphabetic, or alphanumeric value or combination of values. The authentication key 268 can serve as a security token that enables access to one or more computing systems, such as the host device 280. For instance, in some embodiments, when the cryptographic wallet 260 is paired or docked to (e.g., establishes an electronic connection with) the host device 280, the user may be prompted to enter authentication information via the input/output circuit(s) of input/output circuit 284a and/or input/output circuit 284b. The authentication information may include a PIN, a password, a pass phrase, biometric information (e.g., fingerprint, a set of facial features, a retinal scan), a voice command, and/or the like. The authentication circuit 266 can compare the user-entered information to the authentication key 268 and maintain the electronic connection if the items match at least in part.

As shown, the authentication circuit 266 can include retrievably stored configuration information such as configuration information 270. The configuration information 270 can include a numerical, alphabetic, or alphanumeric value or combination of values. These items can be used to enable enhanced authentication protocols. For instance, the configuration information 270 can include a timeout value for an authorized connection between the cryptographic wallet 260 and the host device 280. The configuration information 270 can also include computer-executable code. In some embodiments, for example, where a particular cryptographic wallet, such as cryptographic wallet 260, is set up to pair with only one or a small number of pre-authorized host devices such as host device 280, the configuration information 270 can include a device identifier and/or other device authentication information, and the computer-executable code may be structured to verify the device identifier and/or other device authentication information against the information associated with or provided by the host device 280. When a pairing is attempted, the computer-executable code may initiate or cause the host device 280 to initiate an electronic communication (e.g., an email message, a text message, etc.) using user contact information stored as configuration information 270.

As shown, the digital asset management circuit 272 can include retrievably stored digital asset data, such as the asset key 274. The asset key 274 can be a numerical, alphabetic, or alphanumeric value or combination of values. In some embodiments, the asset key 274 is a private key in a public/private key pair, a portion thereof, or an item from which the private key can be derived. Accordingly, the asset key 274 proves ownership of a particular digital asset stored on a blockchain system 100. The asset key 274 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The cryptographic wallet 260 can be identified as a party to a blockchain transaction on the blockchain system 100 using a unique cryptographically generated address (e.g., the public key in the public/private key pair).

As shown, the digital asset management circuit 272 can also include retrievably stored asset management instructions such as asset management instructions 276. The asset management instructions 276 can include a numerical, alphabetic, or alphanumeric value or combination of values. These items can be used to enable computer-based operations related to managing digital assets identified by the asset key 274. For instance, the asset management instructions 276 can include parameter values, metadata, and/or similar values associated with various tokens identified by the asset key 274 and/or by the blockchain system 100 associated with particular tokens. The asset management instructions 276 can also include computer-executable code. In some embodiments, for example, asset management functionality (e.g., balance inquiry and the like) can be executable directly from the cryptographic wallet 260 rather than or in addition to being executable from the host device 280.

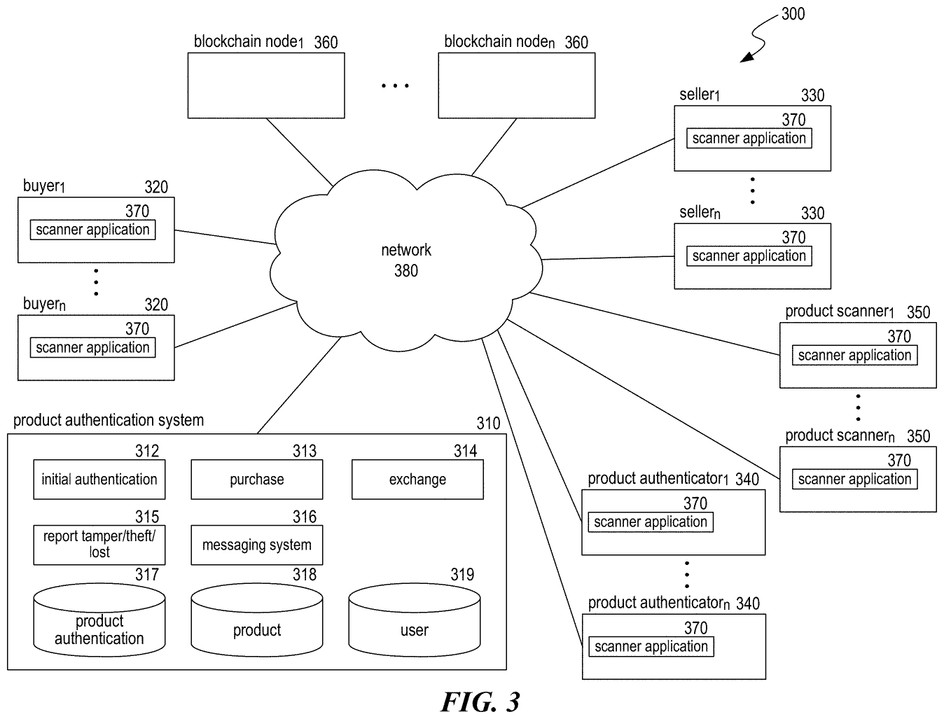

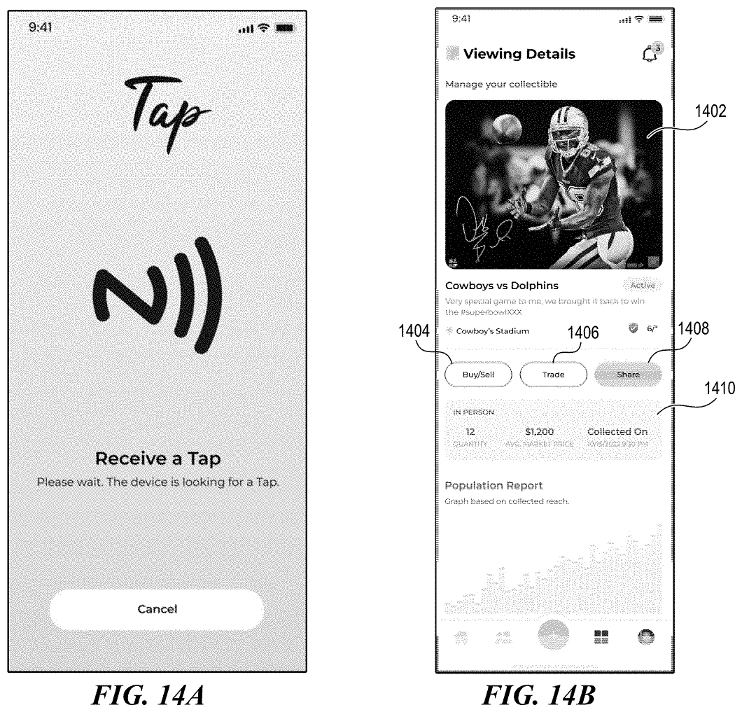

FIG. 3 is a block diagram illustrating an example environment for cryptographic asset generation, in accordance with one or more embodiments. In this example, environment 300 is comprised of system 310, buyer computing systems 320, seller computing systems 330, product authenticator computing systems 340, product scanner computing systems 350, blockchain node computing systems 360, and network 380. Moreover, various computing systems include a scanner application 370. A product is sometimes referred to as a digital collectible, digital art, or a digital signature. The collectible can be an image, formatted text, a video clip, an audio clip, any other digital collectible, or a combination thereof. For example, FIG. 14B illustrates an example collectible 1402. System 310 tracks product authentications and information about authenticated products and is comprised of initial authentication component 312, purchase component 313, exchange component 314, report tamper/theft/lost component 315, messaging system 316, product authentication store 317, product store 318, and user store 319. The system invokes initial authentication component 312 to authenticate and register newly authenticated products in the system.

The system invokes purchase component 313 to facilitate a potential buyer through a product search and purchase transaction. Purchase component 313 invokes exchange component 314 to facilitate communication between a potential buyer and a potential seller of a product. The system invokes report tamper/theft/lost component 315 when a tag is reported as having been tampered with, stolen, or lost. The system also includes messaging system 316 that allows users (e.g., buyers (and potential buyers), sellers (and potential sellers), product authenticators (and potential product authenticators)) to communicate and exchange information about products and facilitates communication leading to the purchase or transfer of products. Product authentication store 317 stores information about authenticated products, such as tag and product identifiers, information about who authenticated the product and when, information about categories for which the product has been authenticated, whether the product has been tampered with, stolen or lost, and so on.

Product store 318 stores general information about products, such as manufacturer, quantity available, cost, description, dimensions, etc. related to products that are available via a marketplace or virtual marketplace provided by the system or another party. User store 319 stores information about individual users (e.g., buyers, sellers, resellers, authenticators) of the system, such as a unique identifier corresponding to the user, demographic information, information about past searches and transactions, etc. Buyer computing systems 320 are used by potential buyers to search for and purchase a product. Seller computing systems 330 are used by sellers (including resellers) to process and finalize purchases requests from potential buyers. Product authenticator computing systems 340 are used by product authenticators to record authenticated product information. One of ordinary skill in the art will understand that buyers, sellers, and authenticators need not be exclusive. For example, a buyer of a product may also later sell that product and vice versa.

Product scanner computing system 350 represents a mobile device that can be used to scan products as they move, for example, through a supply chain to one or more consumers. Blockchain node computing systems 360 represent the nodes of a blockchain network or any other secure, trusted tracking system. In this example, buyer computing systems 320, seller computing systems 330, product authenticator computing systems 340, product scanner computing systems 350, and blockchain node computing systems 360 can communicate via network 380. One of ordinary skill in the art will recognized that various components described herein may be replicated at various computing systems or operate in a distributed fashion across multiple computing devices and systems. For example, although not shown, the components 312-316 can be installed and executed as part of (or in conjunction with) scanner application 370 at buyer computing systems 320, seller computing systems 330, product authenticator computing systems 340, product scanner computing systems 350, and so on.

The computing devices and systems on which the system can be implemented can include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices can include keyboards, pointing devices, touchscreens, gesture recognition devices (e.g., for air gestures), thermostats, smart devices, head and eye tracking devices, microphones for voice or speech recognition, and so on. The computing devices and systems can include desktop computers, laptops, tablets, e-readers, personal digital assistants, smartphones, gaming devices, servers, and computer systems such as massively parallel systems. The computing devices and systems can each act as a server or client to other server or client devices. The computing devices and systems can access computer-readable media that includes computer-readable storage media and data transmission media. The computer-readable storage media are tangible storage means that do not include transitory, propagating signals. Examples of computer-readable storage media include memory such as primary memory, cache memory, and secondary memory (e.g., CD, DVD, Blu-Ray) and include other storage means. Moreover, data may be stored in any of a number of data structures and data stores, such as a databases, files, lists, emails, distributed data stores, storage clouds, etc.

The computer-readable storage media can have recorded upon or can be encoded with computer-executable instructions or logic that implements the system, such as a component comprising computer-executable instructions stored in one or more memories for execution by one or more processors. In addition, the stored information can be encrypted. The data transmission media are used for transmitting data via transitory, propagating signals or carrier waves (e.g., electromagnetism) via a wired or wireless connection. In addition, the transmitted information can be encrypted. In some cases, the system can transmit various alerts to a user based on a transmission schedule, such as an alert to inform the user that a goal for a given period has or has not been met or that one or more changes to a constraint can enable the system to further optimize a goal. Furthermore, the system can transmit an alert over a wireless communication channel to a wireless device associated with a remote user or a computer of the remote user based upon a destination address associated with the user and a transmission schedule in order to, for example, periodically recommend authenticated products. In some cases, such an alert can activate a listings viewer application to cause the alert to display, on a remote user computer and to enable a connection via, a universal resource locator (URL), to a data source over the internet, for example, when the wireless device is locally connected to the remote user computer and the remote user computer comes online.

Various communications links can be used, such as the Internet, a local area network, a wide area network, a point-to-point dial-up connection, a cell phone network, and so on for connecting the computing systems and devices to other computing systems and devices to send and/or receive data, such as via the Internet or another network and its networking hardware, such as switches, routers, repeaters, electrical cables and optical fibers, light emitters and receivers, radio transmitters and receivers, and the like. While computing systems and devices configured as described above are typically used to support the operation of the system, those skilled in the art will appreciate that the system can be implemented using devices of various types and configurations, and having various components.

The system can be described in the general context of computer-executable instructions, such as program modules and components, executed by one or more computers, processors, or other devices, including single-board computers and on-demand cloud computing platforms. Generally, program modules or components include routines, programs, objects, data structures, and so on that perform particular tasks or implement particular data types. Typically, the functionality of the program modules can be combined or distributed as desired in various embodiments. Aspects of the system can be implemented in hardware using, for example, an application-specific integrated circuit (“ASIC”).

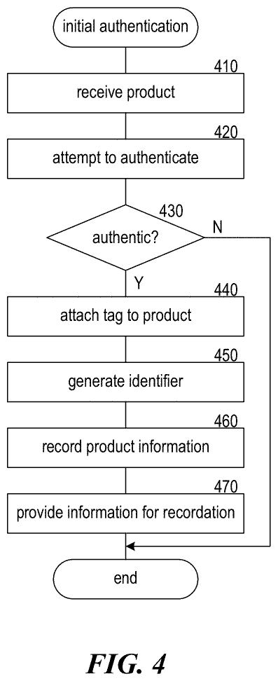

FIG. 4 is a flow diagram illustrating an example process for product authentication, in accordance with one or more embodiments. The product can be a digital collectible. The collectible can be an image, formatted text, a video clip, an audio clip, any other digital collectible, or a combination thereof. The steps shown by FIG. 4 facilitate authentication of a product in one or more categories and register the authenticated product with the system. In block 410, the product is sent to an authenticator for authentication. In block 420, the authenticator attempts to authenticate the product. For example, the authenticator may determine that the product was manufactured by a particular manufacturer, is composed of genuine materials (e.g., genuine leather), is certified by a particular certification authority (e.g., a sustainability certification), and so on. In decision block 430, if the authenticator verifies that the product is authentic, then the component continues at block 440, else the component completes. In block 440, a physical tag is attached to the product, such as a uniquely identifiable Near Field Communication (NFC) tag. In some cases, the physical tag may be attached by the authenticator. In some cases, the product may be shipped back to the owner or a third-party responsible for attaching the physical tags.

In block 450, the component generates an identifier for the product by, for example, generating an identity token for the product, generating a non-fungible token for the product using, for example, the ERC-721 or ERC-1155 standards, applying a hash function (e.g., SHA-256, RIPEMD-160, etc.) to a) the unique identifier associated with the tag, b) a serial number and/or other description information pertaining to the product, including general information (e.g., a stock keeping unit (SKU) code, product type (including, for example, clothing, jacket, shoe, tool, bicycle, recreation, non-perishable, book, collectible, etc.), images of the product, a release date, and so on) and information specific to the product (e.g., information unique to the product, an identifier associated with an owner of the product, condition information, size and/or weight information, manufacture date/time/location, and so on), c) to information about the when the product was authenticated and who authenticated the product, d) to information about who requested the authentication, and so on or any combination thereof.

In block 460, the component records product authentication information in the product authentication store, such as unique identifier associated with the tag attached to the product, the identifier generated for the product, information about the who authenticated the product and when the product was authenticated, and so on. In block 470, the component provides a transaction for recordation in a blockchain or other secure, trusted tracking system, such as a transaction that associates the owner of the product with the unique identifier associated with the tag attached to the product and the generated identifier and signed using a private key (of a public/private key pair) associated with the authenticator. Recording the transaction in the secure, trusted tracking system establishes provenance of the product, and the identifier can be used in transactions (e.g., buying, selling, insuring) to establish a full audit trail of the transactions. One of ordinary skill in the art will recognize that the transaction provided for recordation may include additional information related to the transaction and that various steps performed during the process can be completed using one or more smart contracts.

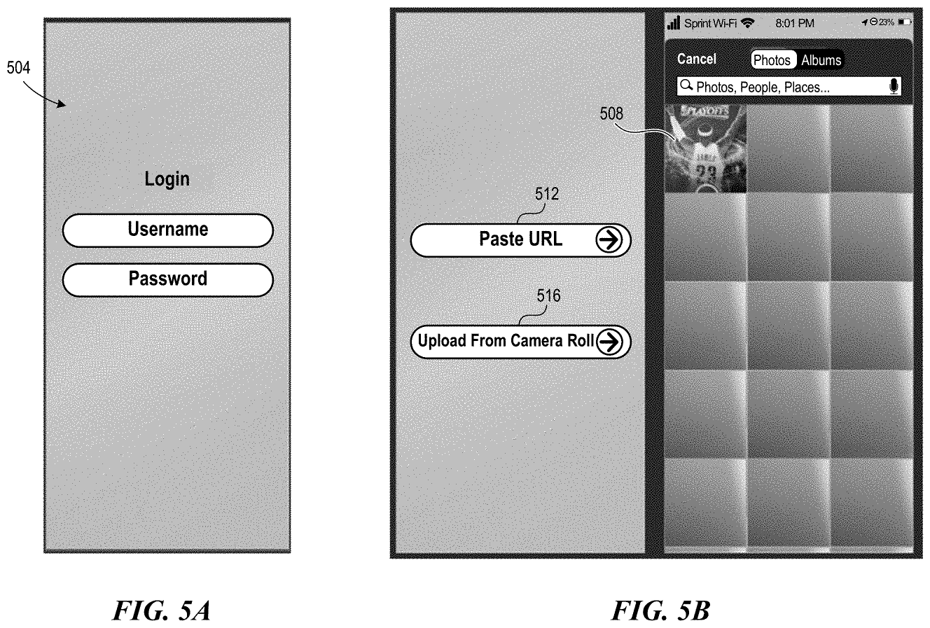

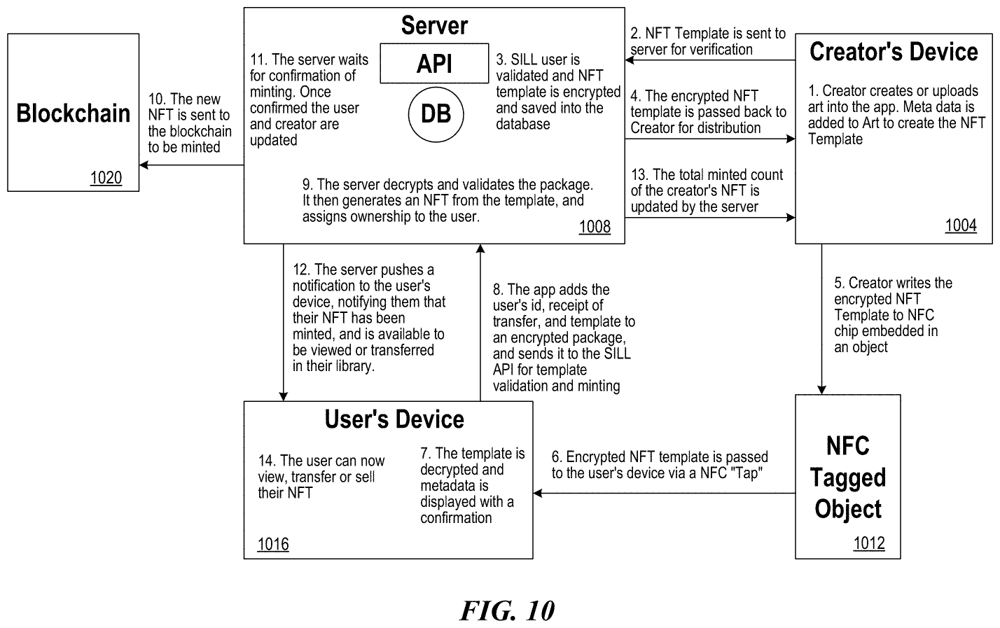

FIG. 5A illustrates an example graphical user interface (GUI) 504 of a cryptographic asset creator device for cryptographic asset generation using short range wireless communication, in accordance with one or more embodiments. The cryptographic asset can be cryptocurrency, a smart contract, one or more NFTs, security tokens, initial coin offerings, utility tokens, crypto ETFs, blockchain funds, etc. In some embodiments, instead of using short range wireless communication, an NFT template can be transferred and an NFT can be minted using the Internet, a local area network, a wide area network, a point-to-point dial-up connection, a cell phone network, and so on for connecting the user devices to the server and blockchain to send and/or receive data. The GUI 504 (sometimes referred to as a creator portal) enables a creator to upload images, collectibles, or other digital works and create NFT templates. An example NFT creator device 1004 is illustrated and described in more detail with reference to FIG. 10. The NFT creator device (sometimes referred to as a transmitter device) can be a desktop, laptop, smartphone, tablet, wearable device, or other user equipment. The NFT creator device can be implemented using the example computer system 1600 illustrated and described in more detail with reference to FIG. 16. The NFT creator can be a celebrity (e.g., athlete, actor, etc.), an influencer, a content provider (e.g., television show), a company, a university, etc.

In some embodiments, an NFT creator device generates an NFT template including a digital collectible and metadata identifying a user of the NFT creator device. For example, the NFT creator logs in to their account using the GUI 504 and their unique creator ID. This ID is used when creating the template, such that the NFT template is generated specifying the creator. The NFT template can include a universal resource link (URL) to the digital collectible, artist (creator) identification, and metadata the creator adds, such as creation time, location, or additional notes.

FIG. 5B illustrates an example graphical user interface (GUI) of a cryptographic asset creator device for NFT generation using short range wireless communication, in accordance with one or more embodiments. Once the creator logs in to the NFT creator device, the creator can create a new NFT by selecting a digital collectible 508 such as an image, a video clip, an audio clip, or any other digital art or collectible from a URL 512, the media library on their device, a networked device, or a camera roll 516 on their device. In some embodiments, a creator at an event can hand out or sell NFTs, e.g., for a particular song at a concert, for the particular concert, etc. For example, a counter can update the NFTs generated as collectors complete a task, register with the creator's server, click on the creator's concert's icon, etc. In other embodiments, NFT creation is performed over NFC or another short range communication technology. The NFT generated serves as digital proof of, e.g., a face-to-face physical contact between the creator and collector, or an in-person, face-to-face digital signature. In some alternate embodiments, a portion of the transaction or the entire transaction is performed in a virtual world, such as a metaverse. For example, a real-world celebrity contact with an NFT collector can occur, which results in an NFT that is usable by the NFT collector's avatar in the metaverse. In other embodiments, a virtual avatar of the NFT creator can virtually transfer an NFT template to an avatar of the NFT collector in the metaverse.

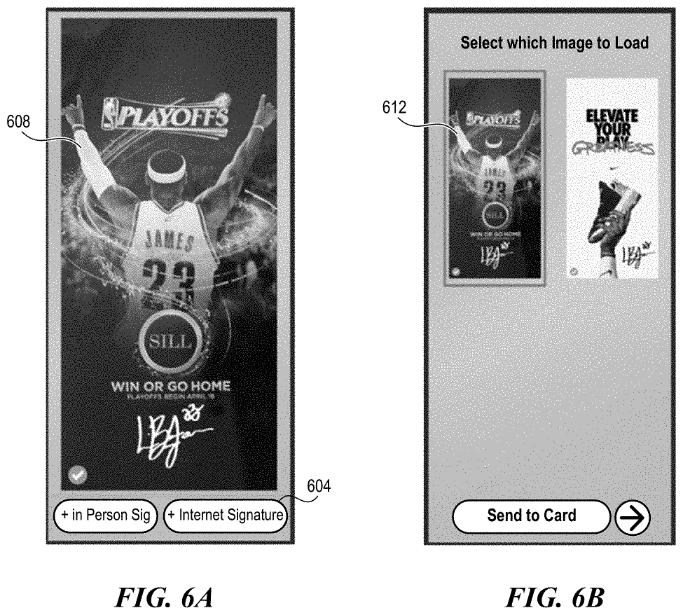

FIG. 6A illustrates an example GUI of a cryptographic asset creator device for cryptographic asset generation using short range wireless communication, in accordance with one or more embodiments. In some embodiments, instead of using short range wireless communication, the NFT template can be transferred and an NFT can be minted using the Internet, a local area network, a wide area network, a point-to-point dial-up connection, a cell phone network, and so on for connecting the user devices to the server and blockchain to send and/or receive data. Once the digital collectible 508 (e.g., art) has been uploaded the creator can choose to add a signature, either by signing the screen or by uploading their previously created “Internet signature” 604. In some embodiments, the Internet signature 604 is a digital or encrypted image of a handwritten or electronic signature that can be attached, stamped, or overlayed onto a digital image. In some embodiments, the Internet signature 604 is a customized logo representing a digital version of the signature, an/autograph, or a custom message. In some embodiments, the Internet signature 604 is a cryptographic signature. In some embodiments, the Internet signature 604 is part of a paid add-on service to provide further security/protection against counterfeits. In some embodiments, the creator can partner with a company, such as an advertising company or product company, to set up NFT templates for an event.

FIG. 6B illustrates an example GUI of a cryptographic asset creator device for cryptographic asset generation using short range wireless communication, in accordance with one or more embodiments. The GUI or an application on the NFT creator device can be used to add a digital collectible 508 (e.g., image) into an art board. In some embodiments, the creator selects the digital collectible from the art board to send to an NFT collector device. An application running on the server, an application running on the creator device, or a combination of applications can upload the digital collectible to the server and save the URL referencing the digital collectible into the NFT template. The NFT creator device adds metadata to the NFT template and/or the digital collectible and the template is uploaded to the server. The server authenticates the request and validates the creator. Once the creator has been validated, the server adds an identification (sometimes referred to as a “Creator ID”) to the NFT template and encrypts the template, sending it back to the NFT creator device. In some embodiments, once a digital collectible is selected, the creator can further add a description to the metadata before generating the NFT template.

In some embodiments, the NFT creator device writes the NFT template to a short range wireless communication device to transmit the NFT template to an NFT collector device (sometimes referred to as a receiver device). An NFT collector can be an individual (or a group of individuals), a company or business entity, a university, a museum, etc. In such embodiments, NFT generation is performed using short range wireless communication. Short range wireless communication technology is used to communicate wirelessly over shorter distances, such as a few millimeters to several meters. Short range wireless communication technology includes near field communication (NFC), Zigbee, Bluetooth, Wi-Fi, radio frequency identification (RFID), Z-wave, infrared (IR) wireless, and equivalents. Other types of short range wireless communication such as 3.84 MHz wireless and minimum-shift keying (MSK) can also be used. NFC is a set of communication protocols for communication between two electronic devices over a distance of 4 cm or less. NFC devices can act as electronic identity documents or keycards. NFC is based on inductive coupling between two antennas present on NFC-enabled devices—for example a smartphone and an NFC card—communicating in one or both directions, using a frequency of 13.56 MHz in the globally available unlicensed radio frequency ISM band using the ISO/IEC 18000-3 air interface standard at data rates ranging from 106 to 424 kbit/s. An NFC-enable devices, such as a smartphone (NFT creator device) can act like an NFC card, allowing users to perform transactions such as payment or ticketing.

Zigbee is a wireless technology developed as an open global standard to address the unique needs of low-cost, low-power wireless IoT networks. The Zigbee standard operates on the IEEE 802.15.4 physical radio specification and operates in unlicensed bands including 2.4 GHz, 900MHz and 868 MHz. Bluetooth technology is a high-speed low powered wireless technology link that is designed to connect phones or other portable equipment together. The Bluetooth specification (IEEE 802.15.1) is for the use of low-power radio communications to link phones, computers, and other network devices over short distances without wires. Wireless signals transmitted with Bluetooth cover short distances, typically up to 30 feet (10 meters). It is achieved by embedded low-cost transceivers into the devices. Wi-Fi is a family of wireless network protocols, based on the IEEE 802.11 family of standards, which are commonly used for local area networking of devices and Internet access, allowing nearby digital devices to exchange data by radio waves. RFID uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data back to the reader. Passive tags are powered by energy from the RFID reader's interrogating radio waves. Active tags are powered by a battery and thus can be read at a greater range from the RFID reader, up to hundreds of meters.

Z-Wave is a wireless communications protocol on a mesh network using low-energy radio waves to communicate from appliance to appliance, allowing for wireless control of devices. A Z-Wave system can be controlled via the Internet from a smart phone, tablet, or computer, and locally through a smart speaker, wireless key fob, or wall-mounted panel. IR wireless is the use of wireless technology in devices or systems that convey data through infrared (IR) radiation. Infrared is electromagnetic energy at a wavelength or wavelengths somewhat longer than those of red light. The shortest-wavelength IR borders visible red in the electromagnetic radiation spectrum; the longest-wavelength IR borders radio waves. In some embodiments, the NFT template is transferred using EMV (a technology based upon a technical standard for smart payment cards named for “Europay, Mastercard, and Visa”). The NFT template transfer uses EMV smart cards, chip cards, integrated circuit cards, or IC cards that store data on integrated circuit chips. The cards can be physically inserted or “dipped” into a reader.

Once the encrypted template has been received by the creator device, the creator is notified that it is ready to be written to their NFC or other short range wireless device or object. In some embodiments, this object is a plastic card having an embedded NFC chip in it, however, there is no limitation to the form factor as long as the chip is embedded close enough to the surface to make a connection. For example, the short range wireless communication device or object can be added to a card, ring or other jewelry, as well as clothing, such as a sweatband. In some alternate embodiments, a portion of the transaction or the entire transaction is performed in a virtual world, such as a metaverse. For example, a virtual avatar of the NFT creator can virtually transfer an NFT template to an avatar of the NFT collector in the metaverse. Thus, the virtual contact between the two avatars in the metaverse generates an NFT that the real-world NFT collector can mint and own on a blockchain.

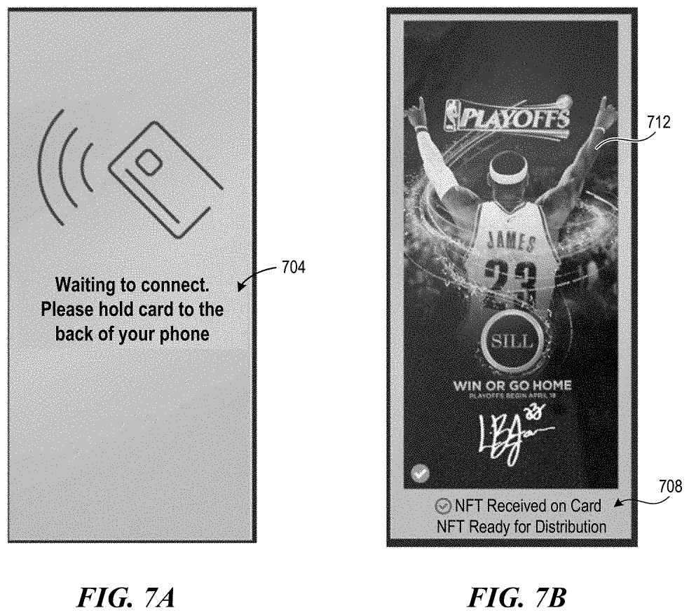

FIG. 7A illustrates an example GUI of a cryptographic asset creator device for cryptographic asset generation using short range wireless communication, in accordance with one or more embodiments. In some embodiments, instead of using short range wireless communication, the NFT template can be transferred and an NFT can be minted using the Internet, a local area network, a wide area network, a point-to-point dial-up connection, a cell phone network, and so on for connecting the user devices to the server and blockchain to send and/or receive data. After the collector taps the “Send to Card” menu option (see FIG. 6B), the application on the NFT creator device waits for an NFC connection. In some embodiments, a message 704 is displayed on the NFT creator device indicating that the NFC card should be held to the NFT creator device. The NFC connection is for writing the NFT template from the NFT creator device to the creator's NFC card. In some embodiments, the NFT templates generated are stored on a server, e.g., the server 1008 illustrated and described in more detail with reference to FIG. 10. The server 1008 can be a cloud server, e.g., an Amazon Web Services (AWS) or Azure server. AWS provides on-demand cloud computing platforms and APIs to individuals, companies, and governments, on a metered pay-as-you-go basis. For example, Amazon Elastic Compute Cloud (EC2) enables users to have at their disposal a virtual cluster of computers, available all the time, through the Internet. In other embodiments, the NFT templates are stored on a blockchain, e.g., the blockchain 1020 illustrated and described in more detail with reference to FIG. 10. In other embodiments, the NFT templates are stored on an InterPlanetary File System (IPFS) server. The InterPlanetary File System is a protocol and peer-to-peer network for storing and sharing data in a distributed file system. IPFS uses content-addressing to uniquely identify each file in a global namespace connecting all computing devices.

FIG. 7B illustrates an example GUI of a cryptographic asset creator device for cryptographic asset generation using short range wireless communication, in accordance with one or more embodiments. Once the NFT template 712 including the digital collectible has been written to the NFC card, the creator can view a confirmation screen with the NFT template 712 and a message 708 indicating that the NFC card is ready for use. The NFC card can now be used to transfer the NFT template 712 to a collector device. NFC tagging is described in more detail with reference to FIG. 10.

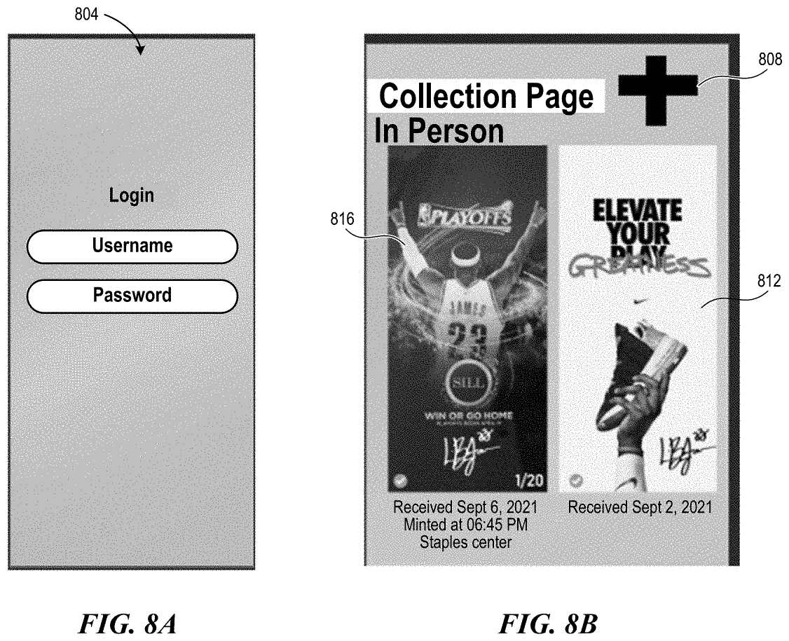

FIG. 8A illustrates an example GUI 804 of a cryptographic asset collector device for cryptographic asset generation using short range wireless communication, in accordance with one or more embodiments. In some embodiments, instead of using short range wireless communication, the NFT template can be transferred and an NFT can be minted using the Internet, a local area network, a wide area network, a point-to-point dial-up connection, a cell phone network, and so on for connecting the user devices to the server and blockchain to send and/or receive data. The NFT collector device (sometimes referred to as a receiver device) can be a desktop, laptop, smartphone, tablet, or other mobile device. The NFT collector device is implemented using the example computer system 1600 illustrated and described in more detail with reference to FIG. 16. The NFT collector device receives an NFT template via a short range wireless communication device or otherwise from an NFT creator device. In some embodiments, the GUI 804 or an application on the NFT collector device enables a user or collector to create an account where they can receive, store and trade their NFTs. The application on the NFT collector device is sometimes referred to as an NFT collector application.

In some embodiments, a user logs in to their account on the NFT collector device with their username and password. This account can be connected to their digital wallet, such that they do not need to work directly with a blockchain wallet. A digital wallet (or e-wallet) is a software-based system that securely stores users' payment information and passwords for numerous payment methods and websites. For example, by using a digital wallet, users can complete purchases easily and quickly with near-field communications technology. The application can manage the functionality for them but also enables them to use a blockchain wallet directly if they are experienced with blockchain wallets. A blockchain wallet is a digital wallet that allows users to store, manage, and trade their cryptocurrencies. Blockchain wallet users can manage their balances of Bitcoin, Ether, and other crypto assets.

FIG. 8B illustrates an example GUI of a cryptographic asset collector device for cryptographic asset generation using short range wireless communication, in accordance with one or more embodiments. After logging in, the collector or user is taken to their collection page where they can see all the NFTs they currently have. For example, FIG. 8B shows NFTs corresponding to the digital collectible 508, 812 and metadata/information related to a location and date of minting. The metadata can be associated with a geolocation and/or geofence using the NFT collector device's GPS. Geolocation refers to the identification of the geographic location of a user or computing device via a variety of data collection mechanisms. Typically, a geolocation service uses network routing addresses or internal GPS devices to determine this location. For example, Geopositioning (also known as geotracking, geolocalization, geolocating, geolocation, or geoposition fixing) can be used to generate metadata associated with the geographic position of the NFT minting. In some embodiments, the NFT is valid or can be minted only if collected within a geofence. A geofence is a virtual perimeter for a real-world geographic area. A geo-fence can be dynamically generated or match a predefined set of boundaries. For example, the NFT can reflect a location-aware device of a location-based service user entering or exiting a geo-fence. The collector can tap an icon 808 (e.g., a plus button) to receive a new NFT. The process of minting an NFT is how digital art becomes a part of the Ethereum blockchain—a public ledger that is unchangeable and tamper-proof. The digital artwork is represented as an NFT so it can then be purchased and traded in the market and digitally tracked as it is resold or collected again in the future.

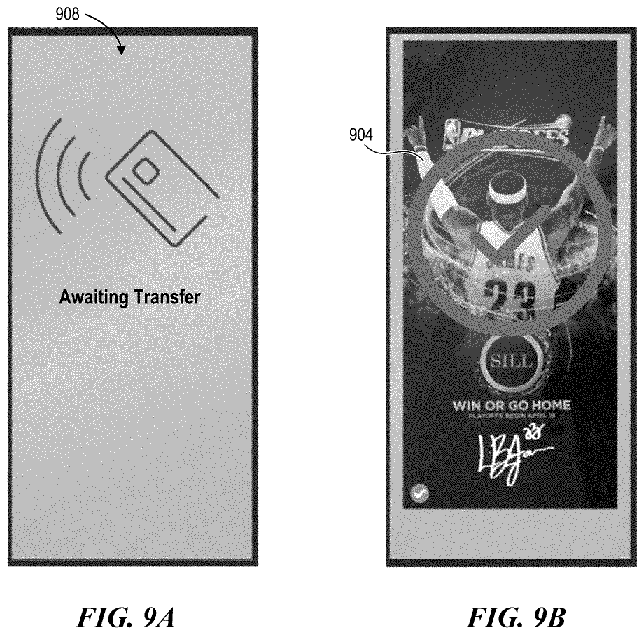

FIG. 9A illustrates an example GUI 804 of a cryptographic asset collector device for cryptographic asset generation using short range wireless communication, in accordance with one or more embodiments. In some embodiments, instead of using short range wireless communication, the NFT template can be transferred and an NFT can be minted using the Internet, a local area network, a wide area network, a point-to-point dial-up connection, a cell phone network, and so on for connecting the user devices to the server and blockchain to send and/or receive data. The GUI 804 shows a message indicating that the application on the NFT collector device is ready to receive a new NFT. The collector waits on this screen until they receive a short range wireless communication from the creator's short range wireless communication device (e.g., an NFC card or NFC tag) or directly from the NFT creator device. NFC tagging is described in more detail with reference to FIG. 10. The NFT distribution process is therefore simpler than traditional methods. Once the NFC object is ready, the creator needs only to touch the back of a collector's phone (NFT collector device) with the NFC object. The process on the collector's phone can be performed in different ways depending on the device and installation status. For example, when the NFT collector application is installed and open on the NFT collector device, and the screen is unlocked, the NFT collector device is ready to receive an NFT template. In this case, the application receives the NFT template via NFC and issues an audible (ding), visible (popup on the device), or tangible (device vibration) notification of receipt. This lets the collector and creator both know that the transfer was successful. If the NFT collector device is temporarily out of service or has a bad wireless or cellular signal, the notification is delivered once the connection is restored.

In some embodiments, the NFT collector device is an Android device having an Android collector application that is installed but not open on the device. The short range wireless communication device (e.g., NFC card or tag) will issue a request to open the collector application. If the collector accepts the request, the collector application will be opened, the collector logs in, and can accept the NFT template. The template data in this case will not have been fully transferred. Only the template ID and request to open the collector application is transferred. Once the collector application is open, the ID is passed to the server and the ID is used to retrieve the entire NFT template. In other embodiments, the NFT collector device is an Apple device having an iOS collector application that is installed but not open on the NFT collector device. The NFC tag will issue a request to open a web URL, which will include the NFT template ID. This will allow the collector to create an account and associate the NFT template with their account. When the collector downloads the collector application and signs it, they will be able to authenticate the NFT template and add it to their account. In yet other embodiments, the NFT collector device has no collector application that is installed on the NFT collector device. The NFC tag, when touched, tapped, or held to the NFT collector device (e.g., a smartphone, tablet, etc.) without the collector application downloaded yet, will request the collector to download the collector application. Once the collector application is downloaded, the collector creates an account and then is able to authenticate and receive the NFT template.

FIG. 9B illustrates an example GUI 804 of a cryptographic asset collector device for cryptographic asset generation using short range wireless communication, in accordance with one or more embodiments. After the collector application has received and confirmed the validity of an NFT template over NFC, the collector application shows the collector a confirmation page with an image of the NFT 904 the NFT collector device received. NFC tagging is described in more detail with reference to FIG. 10. The collector application sends this confirmation to the server to save and mint the NFT 904 for the collector. In some embodiments, once the NFT template has been decrypted and validated by the collector application, it is sent to the server for NFT creation and smart contract execution. The embodiments therefore provide methods for digital artists and athletes to partner together using smart contracts, such that a digital artist can benefit from remuneration using a cryptocurrency in digital transactions. In some embodiments, a digital artist or NFT creator uses machine learning to form groups, identify specific users/NFT collectors, form partnerships, etc., using the example machine learning (ML) system 1000 illustrated and described in more detail with reference to FIG. 10.

A smart contract is a self-executing contract with the terms of the agreement between buyer and seller being directly written into lines of code. The code and the agreements contained therein exist across a distributed, decentralized blockchain network. Smart contracts are described in more detail with reference to FIG. 10. A new package is created that includes the original NFT template, shared secret, collector ID and contact time. This is encrypted with a new secret and sent to the server. The server decrypts the information and creates a new NFT 904 to represent the interaction. A smart contract is executed and this NFT 904 is in the process of being minted. The collector application receives a response confirming that the NFT template was received and validated. The server will wait until the smart contract has been executed and minting has been confirmed on the blockchain. Once complete, it will send a notification to the collector device, informing the collector that their NFT 904 has been minted and is now visible in their library. The creator application will update the number of successful NFT creations for the template, simultaneously thus knowing how many NFTs (e.g., via NFC) the creator has distributed.

In some alternate embodiments, a portion of the transaction or the entire transaction is performed in a virtual world, such as a metaverse. A metaverse is a virtual iteration of the Internet, supporting persistent online 3-D virtual environments through conventional personal computing, as well as virtual and augmented reality headsets. For example, a real-world celebrity contact with an NFT collector can occur, which results in the NFT creator (the celebrity) transferring an NFT template over NFC or the Internet to an NFT collector. Once, the NFT is minted, the NFT is usable by the NFT collector's avatar in the metaverse, e.g., the NFT can become an object in an online game, the NFT can be a trophy that the avatar hangs on a virtual wall in the metaverse, or the NFT can depict a pair of collectible shoes that an avatar wears, etc. In another example, a celebrity athlete can, with a tap at a basketball game, give a fan a pair of his shoes for the fan's avatar to wear in a metaverse. The NFT would be recorded on the blockchain. The methods thus enable real-life interactions to create/produce goods and services in the metaverse. In other embodiments, a virtual avatar of the NFT creator can virtually transfer an NFT template to an avatar of the NFT collector in the metaverse. Thus, the virtual contact between the two avatars in the metaverse generates an NFT that the real-world NFT collector can mint and own on a blockchain.

FIG. 10 is a flow diagram illustrating an example process for cryptographic asset generation using short range wireless communication, in accordance with one or more embodiments. In some embodiments, instead of using short range wireless communication, the NFT template can be transferred and an NFT can be minted using the Internet, a local area network, a wide area network, a point-to-point dial-up connection, a cell phone network, and so on for connecting the user devices to the server and blockchain to send and/or receive data. In some embodiments, the process of FIG. 10 is performed by a computer system, e.g., the example computer system 1600 illustrated and described in more detail with reference to FIG. 16. Particular entities, for example, the server 1008, NFT creator device 1004, or NFT user (collector) device 1016 perform some or all of the steps of the process in other embodiments. Likewise, embodiments can include different and/or additional steps, or perform the steps in different orders.

In action 1, the NFT creator device 1004 retrieves or generates a digital collectible, image, art, audio clip, video clip, or a combination thereof. The digital collectible can be retrieved from a website, social media platform, networked server, etc. An example digital collectible 508 is illustrated and described in more detail with reference to FIG. 5B. In some embodiments, the digital collectible is uploaded into an application running on the NFT creator device 1004. The application is sometimes referred to as an NFT creator application. An example GUI 504 for the NFT creator application is illustrated and described in more detail with reference to FIG. 5A. In some embodiments, the NFT creator device 1004 generates and adds metadata to the digital collectible to create an NFT template. An example NFT template 712 is illustrated and described in more detail with reference to FIG. 7B. Connections between the server 1008, NFT creator device 1004, and NFT user (collector) device 1016 are established using the network 1614 and network adapter 1612 illustrated and described in more detail with reference to FIG. 16.

In some embodiments, the NFT creator device sends the NFT template to the server 1008 for validating the NFT template based on metadata identifying the creator. For example, in action 2, the NFT creator device 1004 sends the NFT template to the server 1008 for verification. In some embodiments, verification is accomplished in two parts. The first part is to verify the encryption of the data. If the data is not properly encrypted it is rejected. Following successful encryption, the NFT template data passed by the NFT collector device is compared with the NFT template data previously passed in by the NFT creator device 1004. The NFT template can include credentials of the creator and identifying data of the NFT creator device 1004.

In action 3, the server 1008 validates the credentials of the creator to determine whether the creator is a genuine user of the NFT generation application and platform. The server 1008 can be a cloud server or local to the NFT creator device 1004. In some embodiments, the server 1008 and NFT creator device 1004 are the same computer device. The server 1008 encrypts the NFT template and saves it in a database. The database can be local to the server 1008 or remote to the server 1008, such as a cloud database. In some embodiments, the encryption is performed using asymmetric encryption, public-key encryption schemes, symmetric-key schemes, triple DES Encryption, RSA encryption, Advanced Encryption Standards (AES), Twofish encryption algorithm, Blowfish encryption algorithm, IDEA encryption algorithm, MD5 encryption algorithm, HMAC encryption algorithm, any other encryption method, or a combination thereof.

The encryption performed ensures fakes and duplicates of the NFT template are prevented from being passed by anyone other than the creator. In some embodiments, the server encrypts the data and includes a shared secret that is verified when the NFT template is decrypted by the application running on the NFT collector device once the NFT collector device receives the NFT template via NFC. Only NFT templates associated with a valid shared secret are accepted by the collector application. Later when the template is uploaded to the server via the collector application, it is decrypted again to ensure that the template is both valid and was collected via an in-person NFC tap or touch. The process of validating keys ensures fake duplicates of the NFT 904 and metadata are not accepted and passed into the blockchain.

In some embodiments, the NFT creator device 1004 receives an encrypted version of the NFT template from the server 1008. The NFT template is encrypted using a shared secret key to prevent duplicates of the NFT template from being generated. For example, in action 4, the server 1008 sends the encrypted NFT template to the NFT creator device 1004 for distribution to collectors. In some embodiments, the NFT creator device 1004 personalizes the NFT template and/or metadata. For example, if the creator is using their NFT creator device instead of a passive NFC chip, the creator has control over personalization and metadata generation. For example, the creator can take an image/selfie with a fan or add the creator's signature or custom logo and then select a menu option saying, e.g., “send to collector.” This will enable the creator to tap the NFT collector device 1016 with the application running on the NFT creator device 1004 open and initiate the secure NFT template transfer. The custom NFT will be minted through the same process used for other templates.

In some embodiments, the NFT creator device 1004 sends the encrypted version of the NFT template received from the server 1008 to the NFT collector device 1016 of a collector for minting the NFT by the collector. For example, in action 5, the NFT creator device 1004 optionally writes the encrypted NFT template to a short range wireless communication device 1012 or object (e.g., an NFC chip, RFID card, etc.). In some embodiments, the short range wireless communication device 1012 is embedded in another object, such as a piece of clothing, a football, or other collectible object. Examples of short range wireless communication technology are described in more detail with reference to FIG. 5A. In some embodiments, the NFT collector device 1016 performs metadata and NFT personalization. For example, the collector opens the collector application on the NFT collector device 1016 and waits for the creator. The collector can then use the collector application to take a picture. This could be of the creator, a selfie of both, or a relevant image from an event (such as a final score, event banner, etc.). The collector then selects “Get Signature” (or any other menu option based on the event/collector). The creator can then look at the image and approve by tapping their NFC card. This card will add their signature or custom logo to the image after it has been validated by the application running on the NFT collector device 1016. This combined image will be used in the NFT that is generated when the application running on the NFT collector device 1016 synchronizes with the server 1008.

In action 6, the encrypted NFT template is passed to an NFT collector device 1016. In some embodiments, the encrypted NFT template is passed to the NFT collector device 1016 via an NFC tap or touch (or other appropriate short range wireless communication means) from the short range wireless communication device 1012. In other embodiments, the encrypted NFT template is passed to the NFT collector device 1016 directly from the NFT creator device 1004, e.g., using Wi-Fi, NFC, etc. If the creator is distributing the NFT template using the NFT creator device 1004 device instead of through a passive NFC chip, the creator can further modify the NFT template on the fly. For example, once the NFT template has been created, the NFT creator device 1004 goes into transmit mode. The NFT creator device 1004 works the same as an NFC chip, sending the NFT template proof-of-contact to each NFT collector device.

In some embodiments, there is an option on the NFT creator device 1004 to “Customize Next.” Selecting this allows the creator to modify the NFT template by adding special metadata to the NFT template. The creator can also modify the digital collectible itself. In such embodiments, a one-time NFT template is created and passed on the next NFC tap or touch. The application running on the NFT creator device 1004 queries the creator whether the creator wishes to return to the previous NFT template or continue with the new NFT template. If the creator decides to continue with the new NFT template, the new NFT template is used but the specific metadata is cleared. The creator will then be able to customize again or use the current new NFT template. In other embodiments, the system performs interactive NFT template generation. This option uses proof of contact to create a more personalized interaction. In this case the NFT template is used as an overlay on an image that is taken during contact. This can be done on the collector's device or the creator's device.

In action 7, the NFT collector device 1016 or an application running on the NFT collector device 1016 decrypts the NFT template. Metadata from the NFT template can be displayed to the user or collector on the NFT collector device 1016. In some embodiments, the NFT creator device 1004 receives a confirmation from the NFT collector device 1016 indicating that the NFT collector device 1016 received the encrypted version of the NFT template for minting the NFT. For example, the GUI 804 of the NFT collector device 1016 further generates a confirmation that the NFT template has been received. For example, the application issues an audible (ding), visible (popup on the device), or tangible (device vibration) notification of receipt. This lets the collector and creator both know that the transfer was successful.

In action 8, the NFT collector device 1016 or an application running on the NFT collector device 1016 augments the NFT template with identification information of the collector and the NFT collector device 1016, and receipts of transfer of the NFT template from the short range wireless communication device 1012 or the NFT creator device 1004 to generate an encrypted data package. The encrypted data package may include metadata associated with the NFT collector device and/or the collector associated with the collector device and the encrypted version of the cryptographic asset template. In some examples, the metadata may include the identifier of the user, receipt of the transfer, and template to the encrypted package.

In some embodiments, the creator enables post-contact customization as an option. In such embodiments, the NFT collector device 1016 can add metadata associated with the collector to the NFT template before minting. For example, a personal note in text (with emoji support), a gif URL, an image URL, any other metadata, or a combination thereof can be added. In case of a gif or image, the collector can select the image or gif they want to use from the NFT collector device 1016. The additional metadata will be passed to the server 1008 and saved. The URL(s) to this image or gif will be saved in the NFT as additional metadata before minting takes place.

The NFT collector device 1016 sends the encrypted data package to the server 1008. In some embodiments, the NFT collector device 1016 uses an application programming interface (API) of the application running on the server 1008 to send the encrypted data package to the server 1008. An API is a software interface connection between computers or between computer programs. The calls that make up the API are also known as subroutines, methods, requests, or endpoints. The NFT collector device 1016 sends the encrypted data package to the server 1008 for template validation and minting.

In action 9, the server 1008 decrypts and validates the encrypted data package. In some embodiments, a “creator unique id,” “template unique id” and “secret key” are compared. Each NFT creator can be assigned a unique ID upon registration that is stored in a server. When an NFT creator authenticates on their NFT creator device 1004, they are provided with their ID (that is not visible to the NFT creator or other users). The ID is passed up to the server with each new template creation request. The server(s) generated a new unique ID for the NFT template and encode it with the server secret key. These are stored in the database and compared to validate with any NFT template transfer requests. The server 1008 generates an NFT from the NFT template and assigns ownership of the NFT to the collector. An example NFT 904 is illustrated and described in more detail with reference to FIG. 9B.

In action 10, the server 1008 sends the NFT to a blockchain 1020 to be minted. In some embodiments, the ERC-721 or ERC-1155 standards are used. The blockchain 1020 is a distributed database that is shared among the nodes of a computer network. As a database, the blockchain 1020 stores information electronically in digital format. The blockchain 1020 maintains a secure and decentralized record of transactions. The blockchain 1020 guarantees the fidelity and security of a record of data and generates trust without the need for a trusted third party. The blockchain 1020 collects information together in groups, known as “blocks” that hold sets of information. Blocks have certain storage capacities and, when filled, are closed and linked to the previously filled block, forming a chain of data known as the “blockchain.” All new information that follows that freshly added block is compiled into a newly formed block that will then also be added to the chain once filled. The blockchain 1020 structures its data into chunks (blocks) that are strung together. This data structure inherently makes an irreversible timeline of data when implemented in a decentralized nature. When a block is filled it is set in stone and becomes a part of this timeline. Each block in the chain is given an exact timestamp when it is added to the blockchain 1020.

In some embodiments, the NFT creator device 1004 receives a notification from the server 1008 comprising an indication that the NFT was minted on the blockchain 1020 and a count of a number of minted NFTs associated with the creator. For example, in action 11, the server 1008 waits for a confirmation from the blockchain 1020 that the NFT has been minted. Once the server 1008 receives the confirmation from the blockchain 1020 that the NFT has been minted, the server 1008 sends notifications to the NFT collector device 1016, the NFT creator device 1004, and any other authorized recipient. In action 12, the server 1008 pushes a notification to the NFT collector device 1016. The notification indicates that the NFT has been minted and that it is available to be viewed or transferred to the collector's library. An example of the NFT collector's library is illustrated and described in more detail with reference to FIG. 8B. In action 13, the server 1008 determines and updates a count of the total number of the creator's NFTs minted on the blockchain 1020 (including by different collectors). The server 1008 sends the updated count of the total number of the creator's NFTs minted on the blockchain 1020 to the NFT creator device 1004. In action 14, the NFT collector device 1016 is enabled to display, transfer, or sell the newly minted NFT.

In some additional embodiments, during an initial authentication phase a trusted product authenticator, such as one or more employees of a manufacturer, a certified expert in particular products, etc., is provided a product for examination to determine whether the product is authentic. The product can be a digital collectible or digital art. For example, employees of a manufacturer may be called upon to determine whether a particular item, such as a particular shoe, handbag, article of clothing, collectible item, etc. is one that was originally manufactured by the manufacturer. As another example, a certified expert in verifying the authenticity of one or more products can be called on to authenticate a product. In another example, a trusted reseller of a product may authenticate that the product was sold by that reseller. If the product is deemed to be authentic, a physical tag is attached to the product and the product is given a unique product identifier, each of which is used to track the product as it is sold and re-sold over the course of its life. For example, after a product is authenticated the owner of the product, a retailer, a reseller, the authenticator, or a third party may attach a tag to the product using previously-received tags or a tag provided in response to the authentication.

Each time the authenticity of the product is subsequently confirmed or otherwise verified as part of a transaction (e.g., a sale), the authenticator can be remunerated for the past authentication. Furthermore, because the product does not need to be re-authenticated, the system avoids any duplicate effort required in re-authenticating the product. In some cases, the authenticator may receive free or discounted physical tags and split the remuneration fee with the physical tag provider. Moreover, the authenticator can provide a transaction for recordation in a secure, trusted tracking system, such as a blockchain or hash graph, indicating that the product has been authenticated by the authenticator on behalf of, for example, the owner of the product. For example, the transaction may include information about the authenticated product signed using a private key of the authenticator. After the transaction is recorded in the secure, trusted tracking system, the authenticity of the product can be verified by subsequent buyers or sellers of the product via a system that is secure and immutable by, for example, analyzing transactions in the secure, trusted tracking system. In this manner, the system provides a secure and trusted mechanism for parties in the supply chain to record and verify a product's authenticity, thereby reducing the amount of time and effort needed to authenticate a product over the course of its life.

In some embodiments, the system uses tamper-proof tags or chips, such as NFC Integrated Circuits (ICs) or dual-frequency ICs tags with a Secure Unique NFC (SUN) mechanism that generates a secure unique NFC message authentication each time the tag is scanned or read, for example, for proof of presence, authentication, and ownership. When a product is sold, the seller can scan the tag to provide proof of ownership and proof of presence and then ship the product to the buyer. When the buyer receives the product, the buyer can scan the tag to confirm and claim ownership. Moreover, the transaction between the buyer and the seller can be recorded in a blockchain transaction to provide further proof of the transaction. Each additional ownership transfer of the product can include a fee back to the original authenticator or authenticators paid for by the buyer, the seller, or both (e.g., one dollar, five dollars, ten percent of the cost to purchase the product, twenty percent of the cost to purchase the product, tokens, points, and so on). Thus, the system expands the authentication services through the lifespan of the authenticated product.

A system can include several components for managing and verifying authentications, including a product authentication blockchain, tagging hardware and software, a scanner application, and/or cryptography and encryption. In some embodiments, the product authentication blockchain manages digital identities and NFC tags, maintains records of ownership of products, manages fees payments for transfer of ownership and product purchase through smart contracts, manages and authenticates buyers and sellers' identities, manages messaging system to log offers from potential buyers, manages and keeps record of products within a virtual marketplace or selling/trading platform, logs stolen, lost, and/or tampered-with products, etc. The tagging hardware and software can include any type of smart tags and related tagging software, including tags described in U.S. Provisional Patent Application No. 63/125,893, NFC tags with Secure Unique NFC (SUN) mechanisms, such as SMARTRAC's CIRCUS PRO (equipped with NXP's NTAG 424 DNA), etc.

The scanner application is a mobile application in communication with the system that reads NFC tags and serves as an interface between resellers, buyers, sellers, products, and the blockchain. Users of the system can use the application to authenticate and verify products, transfer ownership of products, connect to buyers and sellers of products through, for example, a messaging component, view products, flag products as stolen, personalized experiences can be displayed through a scan of the tag on the product, and products can be automatically uploaded to the online marketplace through scanning, touching, or tapping the NFC tag. The product authentication uses cryptography and encryption for messaging, authentication of products, authentication of buyers, authentication of sellers, transaction settlement on the blockchain, NFC tag communication, and so on.

In some embodiments, the system relies on short-range wireless communication devices such as NFC tags attached to physical products and associated transactions issued on a blockchain. Similarly, non-physical tags or tokens can be associated with non-physical goods, such as virtual goods and associated transactions issued on the blockchain. Initially, a product's authenticity is confirmed by one or more individuals trained to recognize authenticity, such as employees of a manufacturer, employees of a reseller, a third-party expert, etc. Once the product is authenticated, a uniquely-identifiable NFC tag is attached to, or associated with, the product, an identifier can be created for the product (such as an identity token), and the NFC Tag and identification information are associated in the system in, for example, a product authentication data store. The identifier created for the product can be a digital cryptographic identifier (e.g., a hash value generated using a secure hashing algorithm), a hash value generated from a description (or partial description) of the product and/or a serial number associated with the product, and so on. Furthermore, information about the product and tag is issued on a blockchain, such as a tag id, current owner, date and time authenticated, authenticator, and so on using a transaction signed using a private key (of a public/private key pair) of the authenticator. In this manner, the system issues a secure digital authenticity certification using the blockchain to store and manage identities and NFC tags and to link the NFC tags to corresponding products.

Furthermore, an authentication flag in the product authentication data store can be updated by the seller for the tag to identify an authentic original product for a corresponding brand. Attaching a tamper-proof tag that certifies authenticity of a product and uniquely and digitally identifies a sold product reduces counterfeits both for tags and products. It also reduces authentication costs as the items are already identified and can be automatically authenticated once they re-enter the market. One of ordinary skill in the art will recognize that physical tags can be attached to products using any number of means for attaching including, for example, adhesives, sewing, stitching, gluing, ironing on, tying, buttoning, fastening, pinning, injecting, embedding, welding, stamping, silk screening, molding, screwing, nailing, and so on.

The system provides features that make it easier for buyers to learn about products and for sellers to make their product available. By scanning a tag associated with a product a potential buyer can trigger the system to send relevant information about the product, including virtual experiences involving the product. For example, scanning a physical tag associated with a hand bag using, for example, a scanner application installed on a mobile device computing system may prompt a user to select from among any number of virtual opportunities, such as a live (or pre-recorded) virtual fashion show of the brand, and so on. Alternatively, by scanning a tag associated with a product a seller can be prompted with an easy to use interface for making their product available for sale in a marketplace, such as a form that allows the user to enter a price for the product, a picture of the product, a description of the product, and so on. Once this information is provided, the scanner application can provide this information to the system so that the product can be made available for purchase.

In some embodiments, the system provides a closed-ecosystem in which users (e.g., buyers, sellers, authenticators) can exchange within a marketplace provided by the system. Because the medium of exchange is part of a closed ecosystem, it can be managed by the system as part of a centralized database. It can be used for to pay for products via an application or interface provided by the system, such as a mobile application or web-based interface, can be transferred among users, and can be used to pay for activities within the application or interface, such as premium services, exclusive offers (e.g., limited items, raffles for giveaways), etc. Furthermore, in some example, one or more tokens or points distributed in the closed ecosystem can be used to purchase physical tags to attach to products for authentication purposes. For example, a vetted and trusted reseller may be able to purchase physical tags to attach to products they sell. When the tags are used to verify the authenticity of a product, the reseller can be remunerated for having previously authenticated the product. Moreover, because authenticity of the product is verifiable by analyzing transactions stored in a trusted blockchain and without consulting the original authenticator (or another authenticator), authentication efforts need not be duplicated, thereby saving valuable resources of the buyer, the seller, the authenticator, etc.

In some embodiments, the system can be employed in a digital realm. For example, rather than (or in addition to) linking physical tags to physical products, the system can use non-fungible tokens associated with items that solely exist as virtual items, such as digital collectables issued by brands, generated from end users activating tags for physical products, and so on. In this manner, the system can be used to authenticate (and verify the authenticity of) virtual items, rather than relying on physical tags attached to physical items. For example, virtual items, such as virtual shirts, shoes, collectible trading cards, and so on, can be associated with non-fungible tokens and transactions involving those virtual items can be recorded in a secure, trusted tracking system, such as a distributed ledger. These virtual items may be used in various contexts, such as items acquired as part of a game, items worn by an avatar in a game or other virtual environment, and so on. Moreover, the system can act as a wallet or closet for users to store their digital items or collectibles, but they can also buy, sell, and trade the collectibles on a secondary marketplace. In some cases, users can obtain virtual items through the purchase of drop boxes that include any number of virtual items or by purchasing or acquiring a corresponding physical item, such as a shirt for the user to wear and a corresponding virtual shirt for the user's avatar to wear in a game or other virtual environment.

Furthermore, the physical item may have an associated tag used for verifying ownership and authenticity of the physical item itself. In some examples, brands or companies generate digital non-fungible tokens that correspond to a specific virtual item and issue these non-fungible tokens as part of a drop box so that the exact virtual item (or items) is not visible at the time of purchase. As such, the user does not know which non-fungible token (and corresponding virtual item) they are purchasing. Furthermore, the system can provide a marketplace for users to search, buy, and sell their virtual items and to provide profile pages to see (or share) the items in their collection. In some cases, non-fungible tokens may be generated and exchanged or transferred using one or more smart contracts. For example, once a user opens a drop box and receives their virtual items, ownership of the virtual items can be transferred to the user and recorded in the blockchain or other secure, trusted tracking system and the user can then hold on to the virtual item, put the virtual item on sale in a virtual marketplace, transfer the virtual item to another user, and so on. If the item is purchased, the system and blockchain can be used to both verify the authenticity of the virtual item and verify that it is owned by the seller before it is transferred out of the current owner's closet and into the new owner's possession.

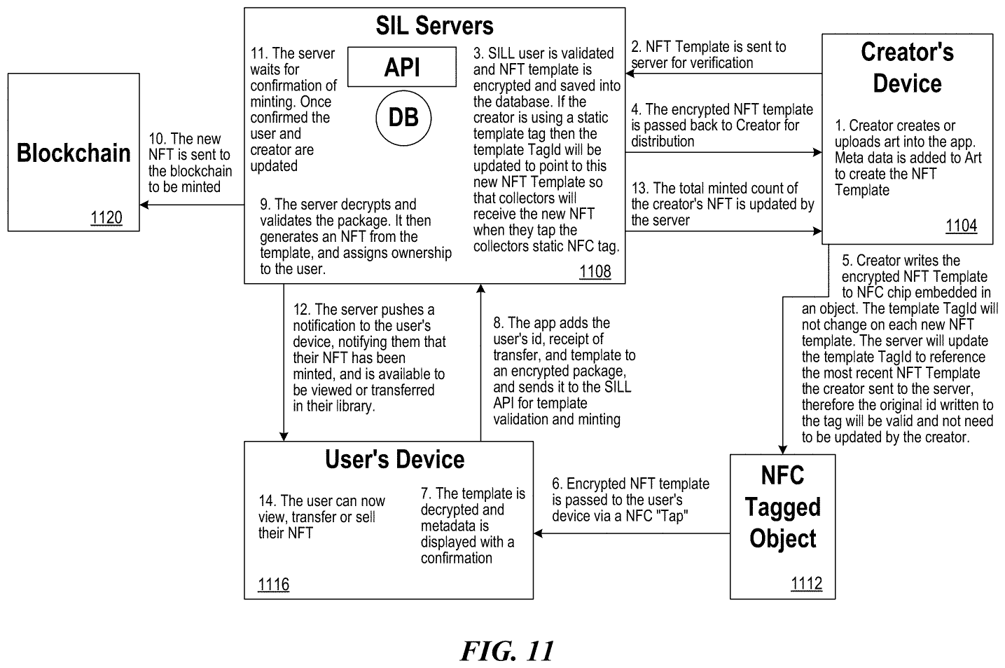

FIG. 11 is a flow diagram illustrating another example process for cryptographic asset generation using short range wireless communication, in accordance with one or more embodiments. As described herein, the NFT template can be transferred and an NFT can be minted using any network for connecting the user devices to the server and blockchain for transmitting and/or receiving data. The process of FIG. 11 is performed by a computer system such as the example computer system 1600 illustrated and described in more detail with reference to FIG. 16. The steps of the process of FIG. 11 may be performed by some or all of server 1108, NFT creator device 1104, NFT user (collector) device 1116, and/or the like. Embodiments described herein may include different and/or additional steps, or perform the steps in different orders.

In action 1, the NFT creator device 1104 retrieves (e.g., uploads) or generates (e.g., creates) a digital collectible, image, art, audio clip, video clip, or a combination thereof. The digital collectible (e.g., such as digital collectible 508 described further with reference to FIG. 5B) can be retrieved from a website, social media platform, networked server, etc. For example, the digital collectible may be uploaded into an application running on the NFT creator device 1104. For example, the application may be the NFT creator application, e.g., as exemplified in part in FIG. 5A by GUI 504. In some embodiments, the NFT creator device 1104 generates and adds metadata to the digital collectible to create an NFT template (e.g., NFT template 712). Connections between the server(s) 1108, NFT creator device 1104, and NFT user (collector) device 1116 are established using the network 1614 and network adapter 1612 illustrated and described in more detail with reference to FIG. 16.

In some embodiments, the NFT creator device sends the NFT template to the server(s) 1108 for validating the NFT template, e.g., based on metadata identifying the creator. For example, in action 2, the NFT creator device 1104 sends the NFT template to the server(s) 1108 for verification. Verification may be accomplished in two parts. For example, the first part includes verifying the encryption of the data. In the first part, if the data is not properly encrypted or determined to be properly encrypted, the NFT template is rejected. Following successful encryption, the NFT template data passed by the NFT collector device is compared with the NFT template data previously passed in by the NFT creator device 1104. The NFT template can include credentials of the creator and identifying data of the NFT creator device 1104.

In action 3, the server(s) 1108 (e.g., local server(s), cloud server(s), etc.) validates the credentials of the creator to determine whether the creator is a genuine user of the NFT generation application and platform. As described herein, the server 1108 can be a cloud server or local to the NFT creator device 1104. In some embodiments, the server 1108 and NFT creator device 1104 are the same computer device. The server 1108 encrypts the NFT template and saves it in a database (e.g., a local database, a remote database, cloud database). According to some embodiments, if the creator is using a static template tag, the template identifier (e.g., “TagId”) may be updated to reference (e.g., point, identify) to the new NFT template such that collectors, e.g., via the application running on the NFT collector device, will receive the new NFT when they receive the NFT template via NFC (e.g., by tapping the collector's static NFC tag).

As described herein, the encryption may be performed using any encryption method, including combinations of different encryption methods. The encryption performed ensures fake NFT templates are not used and that duplicates of the NFT template are prevented from being passed by anyone other than the creator. In some embodiments, the server encrypts the data and includes a shared secret that is verified when the NFT template is decrypted by the application running on the NFT collector device once the NFT collector device receives the NFT template via NFC. Only NFT templates associated with a valid shared secret are accepted by the collector application. Later when the template is uploaded to the server via the collector application, it is decrypted again to ensure that the template is both valid and was collected via an in-person NFC tap or touch. The process of validating keys ensures fake duplicates of the NFT 904 and metadata are not accepted and passed into the blockchain.

In some embodiments, NFT creator device 1104 receives an encrypted version of the NFT template from the server 1108. For example, the NFT template may be encrypted using a shared secret key, e.g., to prevent duplicates of the NFT template from being generated. In action 4, the server 1108 sends the encrypted NFT template to the NFT creator device 1104 for distribution to collectors. In some embodiments, the NFT creator device 1104 personalizes the NFT template and/or metadata. For example, if the creator is using their NFT creator device instead of a passive NFC chip, the creator has control over personalization and metadata generation. For example, the creator can take an image/selfie with a fan or add the creator's signature or custom logo and then select a menu option saying, e.g., “send to collector.” This will enable the creator to tap the NFT collector device 1116 with the application running on the NFT creator device 1104 open and initiate the secure NFT template transfer. The custom NFT will be minted through the same process used for other templates.

In some embodiments, the NFT creator device 1104 sends the encrypted version of the NFT template received from the server 1008 to the NFT collector device 1116 of a collector for minting the NFT by the collector. For example, in action 5, the NFT creator device 1004 optionally writes the encrypted NFT template to a short range wireless communication device 1012 or object (e.g., an NFC chip, RFID card, etc.). According to some embodiments, the template tag identifier (e.g., “TagId”) will not change on each new NFT template. The server will update the template tag identifier (e.g., “TagId”) to reference the most recent NFT template the creator sent to the server, therefore the original identifier written to the tag will be valid and not need to be updated by the creator.

As described herein, in some embodiments, the short range wireless communication device 1112 may be embedded in another object. Examples of short range wireless communication technology are described in more detail with reference to FIG. 5A. In some embodiments, the NFT collector device 1116 performs metadata and NFT personalization. For example, the collector opens the collector application on the NFT collector device 1116 and waits for the creator. The collector can then use the collector application to take a picture (e.g., a picture of the creator, a selfie of both the creator and the collector, or a relevant image from an event as described herein). The collector then selects “Get Signature” (or any other menu option based on the event/collector). The creator can then look at the image and approve by tapping their NFC card. This card will add their signature or custom logo to the image after it has been validated by the application running on the NFT collector device 1116. This combined image will be used in the NFT that is generated when the application running on the NFT collector device 1116 synchronizes with the server 1108.

In action 6, the encrypted NFT template is passed to an NFT collector device 1116 (e.g., via an NFC tap or touch, or other appropriate short range wireless communication means from the short range wireless communication device 1112). Alternatively or additionally, the encrypted NFT template is passed to the NFT collector device 1116 directly from the NFT creator device 1104 (e.g., using Wi-Fi, NFC, etc). If the creator is distributing the NFT template using the NFT creator device 1104 device instead of through a passive NFC chip, the creator can further modify the NFT template on the fly. For example, once the NFT template has been created, the NFT creator device 1104 goes into transmit mode. The NFT creator device 1104 works the same as an NFC chip, sending the NFT template proof-of-contact to each NFT collector device.

In some embodiments, there is an option on the NFT creator device 1104 to “Customize Next.” Selecting this allows the creator to modify the NFT template by adding special metadata to the NFT template. The creator can also modify the digital collectible itself. In such embodiments, a one-time NFT template is created and passed on the next NFC tap or touch. The application running on the NFT creator device 1104 queries the creator whether the creator wishes to return to the previous NFT template or continue with the new NFT template. If the creator decides to continue with the new NFT template, the new NFT template is used but the specific metadata is cleared. The creator will then be able to customize again or use the current new NFT template. In other embodiments, the system performs interactive NFT template generation. This option uses proof of contact to create a more personalized interaction. In this case the NFT template is used as an overlay on an image that is taken during contact. This can be done on the collector's device or the creator's device.

In action 7, the NFT collector device 1116 or an application running on the NFT collector device 1116 decrypts the NFT template. Metadata from the NFT template can be displayed to the user or collector on the NFT collector device 1116. In some embodiments, the NFT creator device 1104 receives a confirmation from the NFT collector device 1116 indicating that the NFT collector device 1116 received the encrypted version of the NFT template for minting the NFT. For example, the GUI 804 of the NFT collector device 1116 further generates a confirmation (e.g., application issues auditory, visible, and/or tactile/tangible notifications) that the NFT template has been received. This lets the collector and creator both know that the transfer was successful.

In action 8, the NFT collector device 1116 or an application running on the NFT collector device 1116 augments the NFT template with identification information of the collector and the NFT collector device 1116, and receipts of transfer of the NFT template from the short range wireless communication device 1112 or the NFT creator device 1104 to generate an encrypted data package. In some embodiments, the creator enables post-contact customization as an option. In such embodiments, the NFT collector device 1116 can add metadata associated with the collector to the NFT template before minting. For example, a personal note in text (with emoji support), a gif URL, an image URL, any other metadata, or a combination thereof can be added. In case of a gif or image, the collector can select the image or gif they want to use from the NFT collector device 1116. The additional metadata will be passed to the server 1108 and saved. The URL(s) to this image or gif will be saved in the NFT as additional metadata before minting takes place.

The NFT collector device 1116 sends the encrypted data package to the server 1008. In some embodiments, the NFT collector device 1116 uses an application programming interface (API) of the application running on the server 1108 to send the encrypted data package to the server 1108. An API is a software interface connection between computers or between computer programs. The calls that make up the API are also known as subroutines, methods, requests, or endpoints. The NFT collector device 1116 sends the encrypted data package to the server 1108 for template validation and minting.

In action 9, the server 1108 decrypts and validates the encrypted data package. In some embodiments, a “creator unique id,” “template unique id” and “secret key” are compared. Each NFT creator can be assigned a unique ID upon registration that is stored in a server. When an NFT creator authenticates on their NFT creator device 1104, they are provided with their ID (that is not visible to the NFT creator or other users). The ID is passed up to the server with each new template creation request. The server(s) generated a new unique ID for the NFT template and encode it with the server secret key. These are stored in the database and compared to validate with any NFT template transfer requests. The server 1108 generates an NFT from the NFT template and assigns ownership of the NFT to the collector. An example NFT 904 is illustrated and described in more detail with reference to FIG. 9B.

In action 10, the server 1108 sends the NFT to a blockchain 1120 to be minted (e.g., using ERC-721 or ERC-1155 standards). The blockchain 1120 is a distributed database that is shared among the nodes of a computer network. As a database, the blockchain 1120 stores information electronically in digital format. The blockchain 1120 may function like blockchain 1020 and/or blockchain 100 as exemplified in FIG. 1.

In some embodiments, the NFT creator device 1104 receives a notification from the server 1108 comprising an indication that the NFT was minted on the blockchain 1120 and a count of a number of minted NFTs associated with the creator. For example, in action 11, the server 1108 waits for a confirmation from the blockchain 1120 that the NFT has been minted. Once the server 1108 receives the confirmation from the blockchain 1120 that the NFT has been minted, the server 1108 sends notifications to the NFT collector device 1116, the NFT creator device 1104, and any other authorized recipient. In action 12, the server 1108 pushes a notification to the NFT collector device 1116. The notification indicates that the NFT has been minted and that it is available to be viewed or transferred to the collector's library. An example of the NFT collector's library is illustrated and described in more detail with reference to FIG. 8B. In action 13, the server 1108 determines and updates a count of the total number of the creator's NFTs minted on the blockchain 1120 (including by different collectors). The server 1108 sends the updated count of the total number of the creator's NFTs minted on the blockchain 1120 to the NFT creator device 1104. In action 14, the NFT collector device 1116 is enabled to display, transfer, or sell the newly minted NFT.

In some additional embodiments, during an initial authentication phase a trusted product authenticator, such as one or more employees of a manufacturer, a certified expert in particular products, etc., is provided a product for examination to determine whether the product is authentic. The product can be a digital collectible or digital art. For example, employees of a manufacturer may be called upon to determine whether a particular item, such as a particular shoe, handbag, article of clothing, collectible item, etc. is one that was originally manufactured by the manufacturer. As another example, a certified expert in verifying the authenticity of one or more products can be called on to authenticate a product. In another example, a trusted reseller of a product may authenticate that the product was sold by that reseller. If the product is deemed to be authentic, a physical tag is attached to the product and the product is given a unique product identifier, each of which is used to track the product as it is sold and re-sold over the course of its life. For example, after a product is authenticated the owner of the product, a retailer, a reseller, the authenticator, or a third party may attach a tag to the product using previously-received tags or a tag provided in response to the authentication.

Each time the authenticity of the product is subsequently confirmed or otherwise verified as part of a transaction (e.g., a sale), the authenticator can be remunerated for the past authentication. Furthermore, because the product does not need to be re-authenticated, the system avoids any duplicate effort required in re-authenticating the product. In some cases, the authenticator may receive free or discounted physical tags and split the remuneration fee with the physical tag provider. Moreover, the authenticator can provide a transaction for recordation in a secure, trusted tracking system, such as a blockchain or hash graph, indicating that the product has been authenticated by the authenticator on behalf of, for example, the owner of the product. For example, the transaction may include information about the authenticated product signed using a private key of the authenticator. After the transaction is recorded in the secure, trusted tracking system, the authenticity of the product can be verified by subsequent buyers or sellers of the product via a system that is secure and immutable by, for example, analyzing transactions in the secure, trusted tracking system. In this manner, the system provides a secure and trusted mechanism for parties in the supply chain to record and verify a product's authenticity, thereby reducing the amount of time and effort needed to authenticate a product over the course of its life.

In some embodiments, the system uses tamper-proof tags or chips, such as NFC Integrated Circuits (ICs) or dual-frequency ICs tags with a Secure Unique NFC (SUN) mechanism that generates a secure unique NFC message authentication each time the tag is scanned or read, for example, for proof of presence, authentication, and ownership. When a product is sold, the seller can scan the tag to provide proof of ownership and proof of presence and then ship the product to the buyer. When the buyer receives the product, the buyer can scan the tag to confirm and claim ownership. Moreover, the transaction between the buyer and the seller can be recorded in a blockchain transaction to provide further proof of the transaction. Each additional ownership transfer of the product can include a fee back to the original authenticator or authenticators paid for by the buyer, the seller, or both (e.g., one dollar, five dollars, ten percent of the cost to purchase the product, twenty percent of the cost to purchase the product, tokens, points, and so on). Thus, the system expands the authentication services through the lifespan of the authenticated product.

A system can include several components for managing and verifying authentications, including a product authentication blockchain, tagging hardware and software, a scanner application, and/or cryptography and encryption. In some embodiments, the product authentication blockchain manages digital identities and NFC tags, maintains records of ownership of products, manages fees payments for transfer of ownership and product purchase through smart contracts, manages and authenticates buyers and sellers' identities, manages messaging system to log offers from potential buyers, manages and keeps record of products within a virtual marketplace or selling/trading platform, logs stolen, lost, and/or tampered-with products, etc. The tagging hardware and software can include any type of smart tags and related tagging software, including tags described in U.S. Provisional Patent Application No. 63/125,893, NFC tags with Secure Unique NFC (SUN) mechanisms, such as SMARTRAC's CIRCUS PRO (equipped with NXP's NTAG 424 DNA), etc.

The scanner application is a mobile application in communication with the system that reads NFC tags and serves as an interface between resellers, buyers, sellers, products, and the blockchain. Users of the system can use the application to authenticate and verify products, transfer ownership of products, connect to buyers and sellers of products through, for example, a messaging component, view products, flag products as stolen, personalized experiences can be displayed through a scan of the tag on the product, and products can be automatically uploaded to the online marketplace through scanning, touching, or tapping the NFC tag. The product authentication uses cryptography and encryption for messaging, authentication of products, authentication of buyers, authentication of sellers, transaction settlement on the blockchain, NFC tag communication, and so on.

In some embodiments, the system relies on short-range wireless communication devices such as NFC tags attached to physical products and associated transactions issued on a blockchain. Similarly, non-physical tags or tokens can be associated with non-physical goods, such as virtual goods and associated transactions issued on the blockchain. Initially, a product's authenticity is confirmed by one or more individuals trained to recognize authenticity, such as employees of a manufacturer, employees of a reseller, a third-party expert, etc. Once the product is authenticated, a uniquely-identifiable NFC tag is attached to, or associated with, the product, an identifier can be created for the product (such as an identity token), and the NFC Tag and identification information are associated in the system in, for example, a product authentication data store. The identifier created for the product can be a digital cryptographic identifier (e.g., a hash value generated using a secure hashing algorithm), a hash value generated from a description (or partial description) of the product and/or a serial number associated with the product, and so on. Furthermore, information about the product and tag is issued on a blockchain, such as a tag id, current owner, date and time authenticated, authenticator, and so on using a transaction signed using a private key (of a public/private key pair) of the authenticator. In this manner, the system issues a secure digital authenticity certification using the blockchain to store and manage identities and NFC tags and to link the NFC tags to corresponding products.

Furthermore, an authentication flag in the product authentication data store can be updated by the seller for the tag to identify an authentic original product for a corresponding brand. Attaching a tamper-proof tag that certifies authenticity of a product and uniquely and digitally identifies a sold product reduces counterfeits both for tags and products. It also reduces authentication costs as the items are already identified and can be automatically authenticated once they re-enter the market. One of ordinary skill in the art will recognize that physical tags can be attached to products using any number of means for attaching including, for example, adhesives, sewing, stitching, gluing, ironing on, tying, buttoning, fastening, pinning, injecting, embedding, welding, stamping, silk screening, molding, screwing, nailing, and so on.

The system provides features that make it easier for buyers to learn about products and for sellers to make their product available. By scanning a tag associated with a product a potential buyer can trigger the system to send relevant information about the product, including virtual experiences involving the product. For example, scanning a physical tag associated with a hand bag using, for example, a scanner application installed on a mobile device computing system may prompt a user to select from among any number of virtual opportunities, such as a live (or pre-recorded) virtual fashion show of the brand, and so on. Alternatively, by scanning a tag associated with a product a seller can be prompted with an easy to use interface for making their product available for sale in a marketplace, such as a form that allows the user to enter a price for the product, a picture of the product, a description of the product, and so on. Once this information is provided, the scanner application can provide this information to the system so that the product can be made available for purchase.

In some embodiments, the system provides a closed-ecosystem in which users (e.g., buyers, sellers, authenticators) can exchange within a marketplace provided by the system. Because the medium of exchange is part of a closed ecosystem, it can be managed by the system as part of a centralized database. It can be used for to pay for products via an application or interface provided by the system, such as a mobile application or web-based interface, can be transferred among users, and can be used to pay for activities within the application or interface, such as premium services, exclusive offers (e.g., limited items, raffles for giveaways), etc. Furthermore, in some example, one or more tokens or points distributed in the closed ecosystem can be used to purchase physical tags to attach to products for authentication purposes. For example, a vetted and trusted reseller may be able to purchase physical tags to attach to products they sell. When the tags are used to verify the authenticity of a product, the reseller can be remunerated for having previously authenticated the product. Moreover, because authenticity of the product is verifiable by analyzing transactions stored in a trusted blockchain and without consulting the original authenticator (or another authenticator), authentication efforts need not be duplicated, thereby saving valuable resources of the buyer, the seller, the authenticator, etc.

In some embodiments, the system can be employed in a digital realm. For example, rather than (or in addition to) linking physical tags to physical products, the system can use non-fungible tokens associated with items that solely exist as virtual items, such as digital collectables issued by brands, generated from end users activating tags for physical products, and so on. In this manner, the system can be used to authenticate (and verify the authenticity of) virtual items, rather than relying on physical tags attached to physical items. For example, virtual items, such as virtual shirts, shoes, collectible trading cards, and so on, can be associated with non-fungible tokens and transactions involving those virtual items can be recorded in a secure, trusted tracking system, such as a distributed ledger. These virtual items may be used in various contexts, such as items acquired as part of a game, items worn by an avatar in a game or other virtual environment, and so on. Moreover, the system can act as a wallet or closet for users to store their digital items or collectibles, but they can also buy, sell, and trade the collectibles on a secondary marketplace. In some cases, users can obtain virtual items through the purchase of drop boxes that include any number of virtual items or by purchasing or acquiring a corresponding physical item, such as a shirt for the user to wear and a corresponding virtual shirt for the user's avatar to wear in a game or other virtual environment.

Furthermore, the physical item may have an associated tag used for verifying ownership and authenticity of the physical item itself. In some examples, brands or companies generate digital non-fungible tokens that correspond to a specific virtual item and issue these non-fungible tokens as part of a drop box so that the exact virtual item (or items) is not visible at the time of purchase. As such, the user does not know which non-fungible token (and corresponding virtual item) they are purchasing. Furthermore, the system can provide a marketplace for users to search, buy, and sell their virtual items and to provide profile pages to see (or share) the items in their collection. In some cases, non-fungible tokens may be generated and exchanged or transferred using one or more smart contracts. For example, once a user opens a drop box and receives their virtual items, ownership of the virtual items can be transferred to the user and recorded in the blockchain or other secure, trusted tracking system and the user can then hold on to the virtual item, put the virtual item on sale in a virtual marketplace, transfer the virtual item to another user, and so on. If the item is purchased, the system and blockchain can be used to both verify the authenticity of the virtual item and verify that it is owned by the seller before it is transferred out of the current owner's closet and into the new owner's possession.

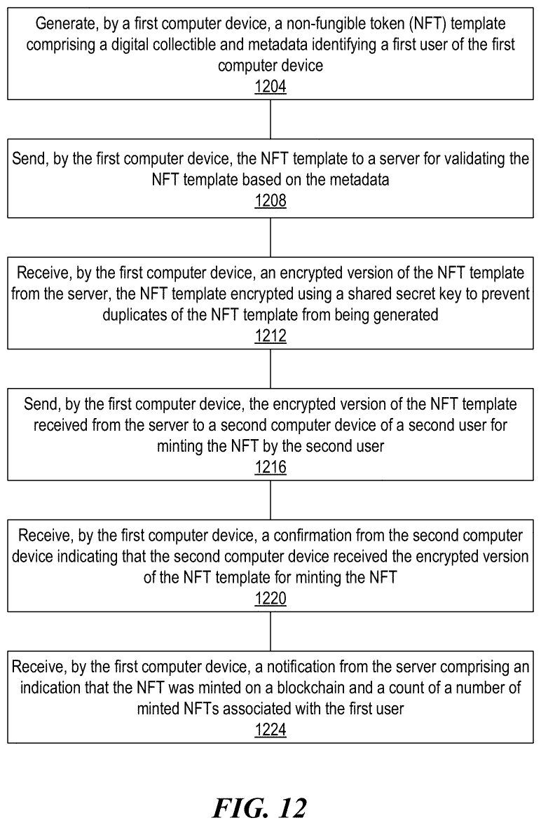

FIG. 12 is a flow diagram illustrating an example process performed by a first computer device for cryptographic asset generation using short range wireless communication, in accordance with one or more embodiments. The process of FIG. 12 may be performed by a computer system such as the example computer system 1600 illustrated and described in more detail with reference to FIG. 16. Embodiments described herein may include different and/or additional steps or perform the steps in different orders.

In step 1204, a first computer device generates a non-fungible token (NFT) template comprising a digital collectible and metadata identifying a first user of the first computer device. For example, the first computer device may be the creator device 1004 and/or 1104 of FIG. 10 and FIG. 11. In some examples, the digital collectible may be uploaded by the creator to the first computer device and the metadata may be added to the digital collectible to generate the NFT template.

In step 1208, the first computer device sends the NFT template to a server for validating the NFT template based on the metadata. In some examples, sending the encrypted version of the NFT template to the second computer device includes writing, by the first computer device, the encrypted version of the NFT template received from the server to a short range wireless communication device. Sending the encrypted version of the NFT template to the second computer device may also include causing the short range wireless communication device to transmit the encrypted version of the NFT template to the second computer device using short range wireless communication. As described herein, short range wireless communication may include at least one of: near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK),In step 1212, the first computer device receives an encrypted version of the NFT template from the server, the NFT template encrypted using a shared secret key to prevent duplicates of the NFT template from being generated. In step 1216, the first computer device sends the encrypted version of the NFT template received from the server to a second computer device of a second user for minting the NFT by the second user. In some examples, minting of the NFT by the second user causes the second computer device to obtain a digital proof of a physical contact between the first computing device (e.g., associated with the first user) and the second computing device (e.g., associated with the second user). In step 1220, the first computer device receives a confirmation from the second computer device indicating that the second computer device received the encrypted version of the NFT template for minting the NFT.

In some examples, prior to sending the encrypted version of the NFT template to the second computer device, the first computer device may personalize, by the encrypted version of the NFT template received from the server using at least one of: an image, a logo, a digital mark/signature, second metadata, a geolocation of the first computer device, a geolocation of the second computer device, a digital ticket, a video, a ticker, or a message.

In step 1224, the first computer device receives a notification from the server comprising an indication that the NFT was minted on a blockchain and a count of a number of minted NFTs associated with the first user. In some embodiments, the notification from the server indicates decryption by the server of the encrypted version of the NFT template from the second computer device using the shared secret key. Alternatively or additionally, the notification from the server may indicate generation of the NFT by the server from the encrypted version of the NFT template.

In some embodiments, the process of FIG. 12 further includes the first computer device personalizing the encrypted version of the NFT template received from the server using at least one of: an image, a logo, a digital signature, second metadata, a geolocation of the second computer device, a digital ticket, a video, or a message prior to sending the encrypted version of the NFT template to the second computer device. In some embodiments, minting the NFT is performed responsive to the geolocation of the second computer device being within coordinates defining a geofence established by the first computer device.

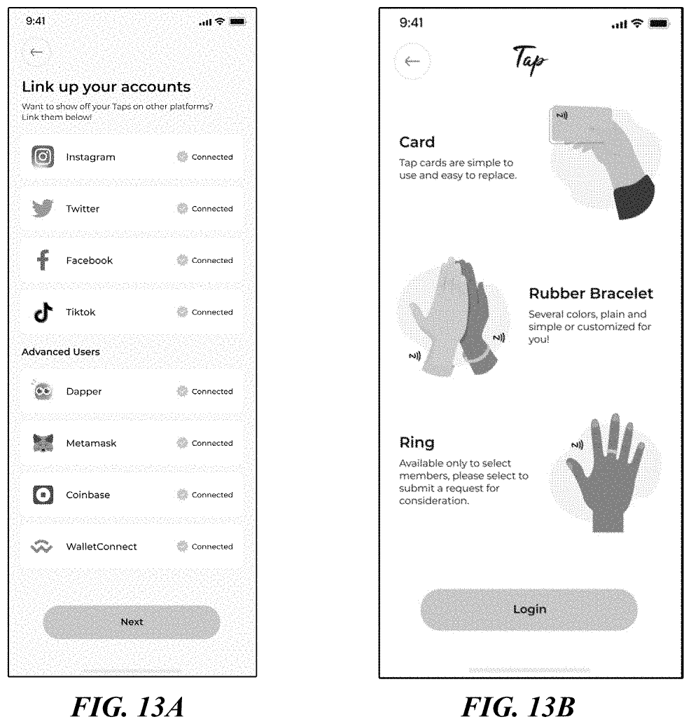

FIG. 13A is a drawings illustrating an example user interface for a creator device, in accordance with one or more embodiments. The user interface of FIG. 13A indicates social media platforms where a collector can post information describing a digital collectible. Although exemplary social media platforms are shown with reference to FIG. 13A, any online platform where users interact to build social networks or relationships can be used. A creator interacting with a creator device can select one or more social media platforms indicated on the user interface and the creator device can open an application corresponding to the social media platform. In some examples, the application prepopulates a user post with a collectible. The creator can use the social media platform to sell their collectible, for example, as described in reference to action 14 of FIGS. 10-11. As described herein, an NFT collector device (e.g., collector devices 1016, 1116) is enabled to display, transfer, or sell the newly minted NFT via social media platforms such as those illustrated in the user interface of FIG. 13A.

In some embodiments, a social media platform interfaces with dedicated marketplaces where a user posts a digital collectible for sale by creating a listing (e.g., on a post). Alternatively or additionally, a user post on a selected social media platform can include a link for purchasing or viewing the collectible. The collectible can be purchased using a cryptographic wallet, such as a digital wallet. For example, the cryptographic wallet described in reference with FIG. 2B is used to purchase the digital collectible. In some embodiments, the cryptographic wallet is linked to or associated with the social media platform or with the system to purchase the collectible.

FIG. 13B is a drawing illustrating another example of a user interface for a creator device, in accordance with one or more embodiments. The user interface of FIG. 13B can indicate to a creator one or more different short-range wireless communication devices, such as NFC tagged objects, using which the creator passes the encrypted NFT template. In some examples, an NFC tap or touch object such as the NFC tagged object 1112 is used. The user interface of FIG. 13B indicates that the creator can use a card, rubber bracelet, and/or ring that is configured to receive the encrypted NFT template, e.g., to an NFC chip embedded in the object. The creator can select the type of object to transmit the encrypted NFT template to. For example, when the collector taps the card menu option, the application on the NFT creator device subsequently waits for an NFC connection. In some embodiments, a message (e.g., message 704) is displayed on the NFT creator device indicating that the NFC card should be held to the NFT creator device.

FIG. 14A is a drawing illustrating an example user interface for a collector device, in accordance with one or more embodiments. As described herein, the user interface indicates that the collector device is primed to receive a communication, e.g., via NFC. For example, as shown by FIG. 14A, the user interface directs a user to receive a tap. The collector device can receive a tap by a passive NFC chip or an NFT creator device (e.g., creator device 1004). The collector device can obtain an NFT template ID in this way. The NFT template ID is passed to a server. The ID is used to retrieve the entire NFT template.

FIG. 14B is a drawing illustrating another example of a user interface for a collector device, in accordance with one or more embodiments. The user interface of FIG. 14B can include a viewing screen where a user views details os a digital collectible, digital art, or a digital signature. For example, FIG. 14B shows a collectible 1402 for a “Cowboys vs. Dolphins” game along with a description and/or associated information. Information 1410 can be displayed along with the digital collectible describing a quantity, an average market price, and a time when the collectible was collected. As described herein, the collectible can be an image, formatted text, a video clip, an audio clip, any other digital collectible, or a combination thereof. The representation of the digital asset can include an image, text, and/or the like. The user interface of FIG. 14B can also include interactive elements, such as buttons, which indicate an action the collector can perform with respect to the digital collectible. For example, the user can select any of options to “buy/sell” 1404, “trade” 1406, or “share” 1408 the digital collectible.

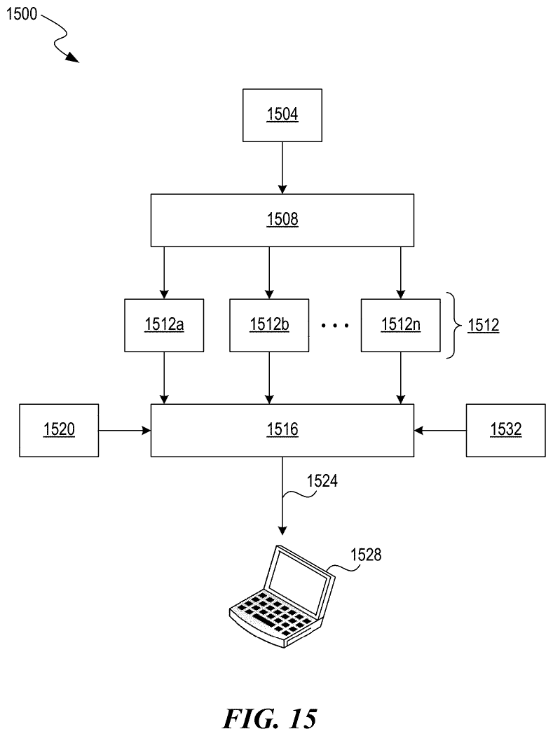

FIG. 15 is a block diagram illustrating an example machine learning (ML) system 1500, in accordance with one or more embodiments. The ML system 1500 is implemented using components of the example computer system 1600 illustrated and described in more detail with reference to FIG. 16. Likewise, embodiments of the ML system 1500 can include different and/or additional components or be connected in different ways. The ML system 1500 is sometimes referred to as a ML module.

The ML system 1500 includes a feature extraction module 1508 implemented using components of the example computer system 1600 illustrated and described in more detail with reference to FIG. 16. In some embodiments, the feature extraction module 1508 extracts a feature vector 1512 from input data 1504. For example, the input data 1504 can include one or more images, sets of text, audio files, or video files. The feature vector 1512 includes features 1512a, 1512b, . . . , 1512n. The feature extraction module 1508 reduces the redundancy in the input data 1504, e.g., repetitive data values, to transform the input data 1504 into the reduced set of features of feature vector 1512, e.g., features 1512a, 1512b, . . . , 1512n. The feature vector 1512 contains the relevant information from the input data 1504, such that events or data value thresholds of interest can be identified by the ML model 1516 by using this reduced representation. In some example embodiments, dimensionality reduction techniques, such as principal component analysis (PCA) or autoencoders are used by the feature extraction module 1508.

In alternate embodiments, the ML model 1516 performs deep learning (also known as deep structured learning or hierarchical learning) directly on the input data 1504 to learn data representations, as opposed to using task-specific algorithms. In deep learning, no explicit feature extraction is performed; the features of feature vector 1512 are implicitly extracted by the ML system 1500. For example, the ML model 1516 can use a cascade of multiple layers of nonlinear processing units for implicit feature extraction and transformation. Each successive layer uses the output from the previous layer as input. The ML model 1516 can learn in supervised (e.g., classification) and/or unsupervised (e.g., pattern analysis) modes. The ML model 1516 can learn multiple levels of representations that correspond to different levels of abstraction, wherein the different levels form a hierarchy of concepts. In this manner, the ML model 1516 can be configured to differentiate features of interest from background features.

In alternative example embodiments, the ML model 1516, e.g., in the form of a CNN generates the output 1524, without the need for feature extraction, directly from the input data 1504. The output 1524 is provided to the computer device 1528. The computer device 1528 is a server, computer, tablet, smartphone, smart speaker, etc., implemented using components of the example computer system 1600 illustrated and described in more detail with reference to FIG. 16. In some embodiments, the steps performed by the ML system 1500 are stored in memory on the computer device 1528 for execution. In other embodiments, the output 1524 is displayed on high-definition monitors.

A CNN is a type of feed-forward artificial neural network in which the connectivity pattern between its neurons is inspired by the organization of a visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 1516 can be a CNN that includes both convolutional layers and max pooling layers. The architecture of the ML model 1516 can be “fully convolutional,” which means that variable sized sensor data vectors can be fed into it. For all convolutional layers, the ML model 1516 can specify a kernel size, a stride of the convolution, and an amount of zero padding applied to the input of that layer. For the pooling layers, the ML model 1516 can specify the kernel size and stride of the pooling.

In some embodiments, the ML system 1500 trains the ML model 1516, based on the training data 1520, to correlate the feature vector 1512 to expected outputs in the training data 1520. As part of the training of the ML model 1516, the ML system 1500 forms a training set of features and training labels by identifying a positive training set of features that have been determined to have a desired property in question and a negative training set of features that lack the property in question. The ML system 1500 applies ML techniques to train the ML model 1516, that when applied to the feature vector 1512, outputs indications of whether the feature vector 1512 has an associated desired property or properties.

The ML system 1500 can use supervised ML to train the ML model 1516, with features from the training sets serving as the inputs. In some embodiments, different ML techniques, such as support vector machine (SVM), regression, naïve Bayes, random forests, neural networks, etc., are used. In some example embodiments, a validation set 1532 is formed of additional features, other than those in the training data 1520, which have already been determined to have or to lack the property in question. The ML system 1500 applies the trained ML model 1516 to the features of the validation set 1532 to quantify the accuracy of the ML model 1516. In some embodiments, the ML system 1500 iteratively re-trains the ML model 1516 until the occurrence of a stopping condition, such as the accuracy measurement indication that the ML model 1516 is sufficiently accurate, or a number of training rounds having taken place.

FIG. 16 is a block diagram illustrating an example computer system 1600, in accordance with one or more embodiments. In some embodiments, components of the example computer system 1600 are used to implement the server 1008, illustrated and described in more detail with reference to FIG. 10. At least some operations described herein can be implemented on the computer system 1600.

The computer system 1600 can include one or more central processing units (“processors”) 1602, main memory 1606, non-volatile memory 1610, network adapter 1612 (e.g., network interface), video displays 1618, input/output devices 1620, control devices 1622 (e.g., keyboard and pointing devices), drive units 1624 including a storage medium 1626, and a signal generation device 1620 that are communicatively connected to a bus 1616. The bus 1616 is illustrated as an abstraction that represents one or more physical buses and/or point-to-point connections that are connected by appropriate bridges, adapters, or controllers. The bus 1616, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 1600 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1600.

While the main memory 1606, non-volatile memory 1610, and storage medium 1626 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1628. The term “machine-readable medium” and “storage medium” shall also be taken to include any medium that is capable of storing, encoding, or carrying a set of instructions for execution by the computer system 1600. In some embodiments, the non-volatile memory 1610 or the storage medium 1626 is a non-transitory, computer-readable storage medium storing computer instructions, which can be executed by the one or more central processing units (“processors”) 1602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1604, 1608, 1628) set at various times in various memory and storage devices in a computer device. When read and executed by the one or more processors 1602, the instruction(s) cause the computer system 1600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory 1610, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1612 enables the computer system 1600 to mediate data in a network 1614 with an entity that is external to the computer system 1600 through any communication protocol supported by the computer system 1600 and the external entity. The network adapter 1612 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 1612 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example machine learning (ML) system 1500 illustrated and described in more detail with reference to FIG. 15.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

We claim:

1. A computer-implemented method for cryptographic asset generation, the computer-implemented method comprising:
generating, by a first computer device, a non-fungible token (NFT) template comprising a digital collectible and metadata identifying a first user of the first computer device;
sending, by the first computer device, the NFT template to a server for validating the NFT template based on the metadata;
receiving, by the first computer device, an encrypted version of the NFT template from the server, the NFT template encrypted using a shared secret key to prevent duplicates of the NFT template from being generated;
sending, by the first computer device, the encrypted version of the NFT template received from the server to a second computer device of a second user for minting an NFT by the second user;
receiving, by the first computer device, a confirmation from the second computer device indicating that the second computer device received the encrypted version of the NFT template for minting the NFT; and
receiving, by the first computer device, a notification from the server comprising: (1) an indication that the NFT was minted on a blockchain, and (2) a count of a number of minted NFTs associated with the first user.

2. The computer-implemented method of claim 1, wherein sending the encrypted version of the NFT template to the second computer device comprises:
writing, by the first computer device, the encrypted version of the NFT template received from the server to a short range wireless communication device; and
causing the short range wireless communication device to transmit the encrypted version of the NFT template to the second computer device using short range wireless communication.

3. The computer-implemented method of claim 2, wherein the short range wireless communication comprises at least one of: near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK).

4. The computer-implemented method of claim 1, wherein minting of the NFT by the second user causes the second computer device to obtain a digital proof of a physical contact between the first computer device and the second computer device.

5. The computer-implemented method of claim 1, further comprising:
prior to sending the encrypted version of the NFT template to the second computer device, personalizing, by the first computer device, the encrypted version of the NFT template received from the server using at least one of: an image, a logo, a digital mark/signature, second metadata, a geolocation of the first computer device, a geolocation of the second computer device, a digital ticket, a video, a ticker, or a message.

6. The computer-implemented method of claim 5, wherein the second computer device is caused to mint the NFT responsive to the geolocation of the second computer device being within coordinates defining a geofence established by the first computer device.

7. The computer-implemented method of claim 1, wherein the notification from the server indicates at least one of: decryption by the server of the encrypted version of the NFT template from the second computer device using the shared secret key, or generation of the NFT by the server from the encrypted version of the NFT template.

8. A computer system comprising:
one or more hardware computer processors; and
at least one non-transitory computer-readable storage medium storing computer instructions, which when executed by the one or more hardware computer processors, cause the computer system to:
receive a cryptographic asset template from a first computer device, the cryptographic asset template comprising: a digital collectible, and metadata identifying a first user of the first computer device;
validate the cryptographic asset template using the metadata;
generate an encrypted version of the cryptographic asset template by encrypting the cryptographic asset template using a shared secret key to prevent duplicates of the cryptographic asset template from being generated;
transmit the encrypted version of the cryptographic asset template to the first computer device;
receive an encrypted data package from a second computer device, wherein the encrypted data package comprises (1) metadata associated with the second computer device, and (2) the encrypted version of the cryptographic asset template;
decrypt the encrypted version of the cryptographic asset template received from the second computer device using the shared secret key to validate the cryptographic asset template; and
responsive to an indication of successful decryption of the encrypted version of the cryptographic asset template received from the second computer device:
generate a cryptographic asset based on the cryptographic asset template;
send the cryptographic asset template to a blockchain for minting the cryptographic asset; and
send a count of a number of minted NFTs associated with the first user to the first computer device.

9. The computer system of claim 8, wherein the second computer device is configured to:
receive, from the first computer device the encrypted version of the cryptographic asset template via short range wireless communication;
decrypt the encrypted version of the cryptographic asset template;
generate the encrypted data package comprising the encrypted version of the cryptographic asset template; and
transmit the encrypted data package to the computer system.

10. The computer system of claim 9, wherein receiving the encrypted version of the cryptographic asset template via the short range wireless communication comprises:
writing, by the first computer device, the encrypted version of the cryptographic asset template received from a server to a short range wireless communication device; and
causing the short range wireless communication device to transmit the encrypted version of the cryptographic asset template to the second computer device using the short range wireless communication.

11. The computer system of claim 10, wherein the short range wireless communication comprises at least one of: near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK).

12. The computer system of claim 8, wherein minting of the cryptographic asset by the second computer device indicates:
obtaining, by the second computer device, a digital proof of a physical contact between the first user and a second user associated with the second computer device.

13. The computer system of claim 8, wherein the computer instructions cause the one or more hardware computer processors to perform operations comprising:
prior to sending the encrypted version of the cryptographic asset template to the second computer device, personalizing, by the first computer device, the encrypted version of the cryptographic asset template received from a server using at least one of: an image, a logo, a digital mark/signature, second metadata, a geolocation of the first computer device, a geolocation of the second computer device, a digital ticket, a video, a ticker, or a message.

14. The computer system of claim 13, wherein minting the cryptographic asset is performed responsive to the geolocation of the second computer device being within coordinates defining a geofence established by the first computer device.

15. The computer system of claim 8, wherein the computer instructions cause the one or more hardware computer processors to perform receiving, by the first computer device, a notification from a server comprising an indication that the cryptographic asset was minted on a blockchain and a count of a number of minted cryptographic assets associated with the first user, and
wherein the notification from the server indicates at least one of: decryption by the server of the encrypted version of the cryptographic asset template from the second computer device using the shared secret key or generation of the cryptographic asset by the server from the encrypted version of the cryptographic asset template.

16. A non-transitory computer-readable storage medium storing computer instructions, which when executed by one or more computer processors, cause the one or more computer processors to:
receive an encrypted version of a cryptographic asset template from a first computer device, the cryptographic asset template comprising a digital collectible and first metadata identifying a first user of the first computer device, the cryptographic asset template encrypted by a server using a shared secret key;
decrypt the encrypted version of the cryptographic asset template using the shared secret key;
generate an encrypted data package comprising the cryptographic asset template and at least one of: second metadata associated with a second user of a second computer device, a message with emoji support, a gif URL, or an image URL;
send the encrypted data package to the server for minting an cryptographic asset;
receive a confirmation from the server indicating that the server received the encrypted version of the cryptographic asset template for minting the cryptographic asset; and
receive a notification from the server comprising an indication that the cryptographic asset was minted on a blockchain.

17. The non-transitory computer-readable storage medium of claim 16, wherein receiving the encrypted version of the cryptographic asset template from the first computer device comprises:
writing, by the first computer device, the encrypted version of the cryptographic asset template received from the server to a short range wireless communication device; and
receiving, using the short range wireless communication device, the encrypted version of the cryptographic asset template.

18. The non-transitory computer-readable storage medium of claim 17, wherein short range wireless communication of the short range wireless communication device comprises at least one of: near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK).

19. The non-transitory computer-readable storage medium of claim 16, wherein minting of the cryptographic asset by the second computer device indicates:
obtaining, by the second computer device, a digital proof of a physical contact between the first user and the second user.

20. The non-transitory computer-readable storage medium of claim 16, wherein the computer instructions cause the one or more computer processors to perform operations comprising:
prior to receiving the encrypted version of the cryptographic asset template from the first computer device, personalizing, by the first computer device, the encrypted version of the cryptographic asset template received from the server using at least one of: an image, a logo, a digital mark/signature, second metadata, a geolocation of the first computer device, a geolocation of the second computer device, a digital ticket, a video, a ticker, or a message.
